(19) United States
(12) Patent Application Publication
(10) Pub. No.: US 2007/0008310 A1
(43) Pub. Date: Jan. 11, 2007

(54) Method for generating a three-dimensional display

(75) Inventors: Joerg Hahn, Leinfelden-Echterdingen (DE); Konrad Polthier, Berlin (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 11/153,116

(22) Filed: Jun. 15, 2005

(30) Foreign Application Priority Data
Jun. 15, 2004 (DE) DE 102004028880.1
Sep. 17, 2004 (DE) DE 102004045121.4
Sep. 17, 2004 (DE) DE 102004045119.2
Jan. 25, 2005 (DE) DE 102005003427.6
Jan. 25, 2005 (DE) DE 102005003428.4
Jan. 25, 2005 (DE) DE 102005003426.8

(51) Int. Cl. G06T 15/00

(52) U.S. Cl. 345/419

(57) ABSTRACT

Methods, data processing systems and computer program products for automatically generating a display of an illuminated physical object on a video display unit of a data processing system are described. Pixels of a predefined model (8) of the object are selected. For each selected pixel (BP) a first light intensity (LI_BP_{—}1) of the pixel (BP) resulting from a first illumination of the object and a second light intensity (LI_BP_{—}2) resulting from a second illumination of the object are calculated. The two light intensities (LI_BP_{—}1, LI_BP_{—}2) are combined to yield a total light intensity (LI_BP_tot), which is transformed into an input signal (ES_BP) for the pixel (BP) processable by the video display unit. Using the pixels and their input signals, the display (9) of the object is generated, transmitted to the video display unit and displayed on the latter.

The present invention relates to methods, data processing systems, and computer program products for automatically generating a display of an illuminated physical object on a visual display unit of a data processing system.

In particular when constructing a physical object, e.g., a motor vehicle, a computer-accessible three-dimensional display of the object that is automatically generated by a data processing system is needed. This display, to be shown on an output device, should be as realistic as possible.

The display to be generated should be available as early as possible in the product manufacturing process. Therefore, generating it should not require a physical exemplar or a physical model of the object to have been manufactured already. Therefore, a photograph or the like is out of the question as a display. Instead, the display is generated with the help of a computer-accessible surface model which represents at least the surface of the object. This surface model is preferably generated from a computer-accessible design model, e.g., a CAD model.

A realistic three-dimensional display of the illuminated object, i.e., a display which shows how the object appears in predefined lighting, is desired. This display is generated with the help of the predefined surface model and is made up of pixels.

In 1942 a mathematical model of an overcast sky had already been presented by P. Moon and D. E. Spencer 1942: “Illumination from a Non-Uniform Sky,” Illuminating Engineering, No. 37 (1942), pp. 707-726. The intensity of the illumination from the direction of a sky element depends on the angle between the direction of the zenith (perpendicular to the earth's surface upward) and the direction of the sky element. The illumination of interior spaces under daylight is described analytically using this model. The application field was in the planning of buildings before construction. The model describes the brightness of rooms but not the appearance of objects under daylight or other illumination.

According to U.S. Pat. No. 6,175,367 B1, the brightness value of a pixel is calculated so that the value depends on the direction of a normal vector onto the surface model at the pixel, the direction of viewing the surface model, the direction of incidence and the lighting intensity of the light source, as well as reflection properties of the surface of the object.

According to U.S. Pat. No. 6,078,332, the illumination of an object by multiple light sources is also simulated. For each pixel of the surface model, a determination of which light sources illuminate the pixel and which do not is performed. For each light source, a damping factor based on the pixel is calculated. Depending on the lighting intensity of the particular light source and the damping factor, a brightness value of the pixel is calculated.

According to EP 1202222 A2, the direction of incidence and the direction of emergence of light are determined. A “bidirectional reflection distribution function” is predefined and used. This describes how an incident beam of light is distributed in various directions with different intensity.

According to U.S. Pat. No. 6,441,820 B2, the illumination of an object by multiple light sources, each of limited dimensions, is simulated, e.g., by multiple artificial light sources. The multiple light sources are replaced approximately by a single punctiform light source; the position and direction of a single light source are varied on a trial basis in a simulation until a maximum degree of agreement between the illumination by multiple light sources and that of a single light source is found. The light source having this position and direction is used as the equivalent light source.

DE 19958329 A1 describes a method of generating a display of an illuminated object on a visual display unit of a data processing system. The object is broken down into display elements (“basic constructs”). It is calculated whether a basic construct appears illuminated or in shadow in the display.

DE 10 2004 028880 A1 describes a method which generates a realistic display of an object illuminated by daylight. This display shows how the object appears when illuminated by natural daylight.

In U.S. Pat. No. 5,467,438 a method for generating a color display of an object is described. The color hue and light intensity of a surface element (“patch”) of the display are determined as a function of the reflection properties of the surface of the object, the maximum possible reflection, and the light intensity of a standard white. The angle between a normal on the surface element and the direction of incidence of the light is taken into account.

According to U.S. Pat. No. 5,742,292 and U.S. Pat. No. 6,504,538 BI, methods and devices by which a color display of an illuminated object is generated are described. The reflection of the surface is taken into account here. In addition, a direction of incidence of light and a direction of viewing are also taken into account in U.S. Pat. No. 6,504,538 B1.

An illuminated physical object shows highlights on its surface even if the surface is relatively matte and the object has only diffuse lighting. Such a highlight appears to run over the surface of the object when the direction of viewing changes.

A generalized Phong model and a computer graphics method are described in U.S. Pat. No. 6,175,367 B1. A computer-accessible surface model of an object, a normal vector at a pixel of the surface model, a direction of viewing, the direction from which a punctiform source illuminates the object, and the lighting intensity are predefined. Depending on these directions, the lighting intensity and reflection properties of the surface of the object, a brightness value, and a color coding for the pixel are calculated by approximation.

U.S. Pat. No. 6,552,726 B1 describes a method of generating a display showing an object from a predetermined direction of viewing. Color values of pixels are calculated in advance and stored temporarily. Depending on the direction of viewing, the color values of pixels to be displayed are recalculated and reused. Displays with highlights generated according to a Phong method are mentioned.

U.S. Pat. No. 6,433,782 B1 describes a computer-accessible design of the object. Its surface is broken down into surface elements. With the help of a normal vector on each surface element and a vector in the direction of the strongest illumination, a brightness value is calculated (see FIG. 20, for example). The light source emits diffuse light in one embodiment. Polar coordinates are preferably used and an angle between two vectors is calculated with the help of their scalar product.

The method according to U.S. Pat. No. 6,545,677 B2 models how a surface reflects an illumination by a punctiform source. A highlight angle is calculated, e.g., as the angle between the direction of viewing and the reflected incident light or approximately as the angle between the normal vector and a half-way vector which bisects the angle between the normal vector and the direction of viewing. The surface is broken down into surface elements and a value depending on how the highlight angle is calculated.

US 2003/0234786 A1 describes how the behavior of a reflective surface may be described by a “bidirectional reflectance distribution function.” A method for approximating this function is presented.

US 2004/0109000 A1 presents a method for generating a display of an illuminated object. The direction of illumination and the position of highlights are calculated. U.S. Pat. No. 6,407,744 B1 describes a method for calculating a display of an illuminated object having highlights.

EP 1004094 B1 describes a method and a device for displaying a textured display of an object on a visual display unit. A direction of illumination of a light source in a three-dimensional coordinate system is taken into account. The calculated light intensity of a pixel of the display is encoded with 8-bit values. The surface of the design model is broken down into surface elements, and a normal vector is calculated for each surface element and stored temporarily. A shading value and a glossiness parameter are calculated for each surface element as a function of the direction of illumination and the particular normal vector. Polar coordinates are preferred for use.

Ch. Poynton: “Digital Video and HDTV,” Morgan Kaufmann, San Francisco, 2003, pp. 271 ff., describes the gamma behavior of a cathode ray tube (CRT). The light intensity with which the video display unit displays a pixel is not proportional to the analog value of the input signal that is sent to the video display unit and determines the coded setpoint light intensity. The gamma behavior, i.e., the correlation between the input signal ES for the setpoint light intensity and the actual light intensity L with which the video display unit displays the pixel is described in Ch. Poynton, loc. cit., p. 272 by the function L=ES^{γ}^{_{—}}^{BG}.

The factor γ_BG is the “gamma factor” (“display γ”) of the video display unit and the non-proportional behavior of the video display unit is referred to as gamma behavior. Gamma factor γ depends on the video display unit and is usually between 2.2 and 2.9.

To compensate for the gamma behavior, Ch. Poynton, loc. cit., p. 274 proposes that the electronic signal be subjected to compensation of the gamma behavior. The gamma correction is performed in a buffer memory connected in-between (“frame buffer”). This buffer memory preferably belongs to the graphics hardware, e.g., to a graphic card. The coding of the setpoint color value is sent to the buffer memory. The buffer memory performs the compensation and sends the electric signal to the video display unit. The buffer memory preferably analyzes a look-up table to perform the compensation.

Ch. Poynton, loc. cit., pp. 274 ff. proposes that color coding FC in the form of an RGB vector be transmitted as an input signal to the buffer memory. The buffer memory generates signal ES for the video display unit according to the formula ES=FC^{γ}^{_{—}}^{comp}. If the first model is correct, it then holds that L=ES^{γ}^{_{—}}^{BG}=(FC^{γ}^{_{—}}^{comp})^{γ}^{_{—}}^{BG}=FC^{(γ}^{_{—}}^{comp·Y}^{_{—}}^{BG)}.

Ch. Poynton, loc. cit., p. 273, also reports that a video display unit often does not correctly reproduce black hues (“black level error” ε_BG). The relationship between L and V is described by L=(ES+ε_BG)^{γ}.

Gamma behavior is also described by T. Akenine-Möller and E. Haines: “Real-time Rendering,” A. K. Peters, 2^{nd} edition, 2002, pp. 109 ff. The relationship between L and V is described there by L=α·(V+ε_BG)^{γ}.

The ITU 709 recommendation proposes using a value of 0.45 for γ_comp, a value of 0.099 for ε, and a value of 0.9099 for α, cf. Ch. Poynton, loc. cit., p. 277. For minor color coding, a gain factor of β and α threshold of Δ are used. The following method is used for red value, the green value, and the blue value. First, an electric signal V1 is calculated from color coding FC (an integer between 0 and 255) according to the formula V1=255·ITU_{—}709 (FC/255), where

$$\begin{matrix}ITU ( x ) = β \cdot x & if x \leq Δ \\ ITU ( x ) = \frac{1}{α} ( {x}^{y\_comp} ) - ɛ\_BG & if x > Δ .\end{matrix}$$

An integer V, which is a valid color code, is then calculated from V1. First, V1 is rounded up or down to the next integer N. The following formulas are used next:
V=N if 0≦ON≦55
V=0 if N<0
V=255 if N>255.

One object achieved by the present invention is to provide a method and a device for automatically generating a three-dimensional computer-accessible display of an illuminated object by which a realistic display of the object is generated with less complexity than with known methods in the case when the object is illuminated by diffuse lighting.

Another object achieved by the present invention is to provide a method and a device for automatically generating a three-dimensional computer-accessible display of an illuminated object by which a realistic display of the object is generated with less complexity than with known methods in the case of diffuse lighting of the object, the display showing the highlights on the surface of the object caused by the illumination in a realistic manner.

Another object achieved by the present invention is to provide a method by which an object illuminated by a light source is displayed on a video display unit of a data processing system in such a way that the display to be generated shows the illumination of the object in a physically correct manner by superimposing two light sources.

Another object achieved by the present invention is to provide a method and a device by which an object illuminated by a light source is displayed on a video display unit of a data processing system in such a way that the display to be generated with a given quantity of processable input signals shows the influence of the distance between the light source and the object in a physically correct manner.

Another object achieved by the present invention is to provide a method for correctly displaying an illuminated object on the video display unit, the method yielding more uniform transitions in the display than known methods, even in the case of dark tones, and it also takes into account the gamma behavior of the video display unit.

The method as recited in Claim 1 includes the following steps:

The following are given:

a computer-accessible three-dimensional surface model of the object,

breakdown of this surface model into surface elements,

a direction of illumination

and a brightness function.

The direction of illumination is a direction of a light acting on the object in one direction, e.g., the direction from which the sun strikes the object.

The given brightness function HF has the angles of 0° to 180° as the set of arguments. It assigns a function value of 0 to the argument 1800 and assigns one function value greater than 0 to each argument smaller than 180°. The image set, i.e., the set of function values, is thus the set of real numbers greater than or equal to 0. All angles smaller than 180° thus have a function value greater than 0. The brightness function describes the effect of the illumination on an illuminated object.

For each surface element of the breakdown, at least one normal is calculated. In addition, the angle between these normals and the given direction of illumination is calculated. This angle is between 0° and 180°, i.e., in the set of arguments of the brightness function. At an angle of 0°, the direction of illumination runs parallel to the normal and is therefore perpendicular to the surface element.

For each surface element, at least one brightness value HW is calculated. For this, function value HF(θ) is calculated, which the given brightness function HF assumes when angle θ between the normal and the direction of illumination is the argument of brightness function HF. This function value is greater than or equal to 0 and is used as brightness value HW of the surface element. Therefore HW=HF(θ).

Using the surface model, the surface elements, and their brightness values, a three-dimensional computer-accessible display of the object is generated in such a way that the greater its brightness value, the brighter a surface element is displayed.

The method as recited in Claim 6 includes the following method steps:

The following are given:

a computer-accessible three-dimensional surface model of the object,

breakdown of the surface model into surface elements,

a direction of illumination \vec{r},

a direction of viewing \vec{v},

and a highlight function GF.

Direction of illumination \vec{r} is a direction of an illumination acting on the object. Direction of viewing \vec{v} is the direction from which the display to be generated shows the object. In the case of a perspective display by central projection, the direction of viewing is the direction from the center of the central projection to an area of the surface of the object to be displayed. The display to be generated should thus show the object from direction of viewing \vec{v}.

The given highlight function GF has angles from 0° to 180° as the set of arguments. It assigns a function value of 0 to the argument 180° and one function value greater than 0 to each argument smaller than 180°. The image set of highlight function GF, i.e., the quantity of function values, is thus the set of real numbers greater than or equal to 0. All angles smaller than 180° thus have a function value greater than 0. Highlight function GF describes the intensity of the highlight caused by light reflected by the surface of the object.

For each surface element of the breakdown, at least one normal \vec{n} which is perpendicular to the surface element is calculated. In addition, angle θ between this normal \vec{n} and given direction of illumination \vec{r} is calculated. This angle is between 0° and 180°. At an angle of 0°, direction of illumination \vec{r} runs parallel to normal \vec{n} and is therefore also perpendicular to the surface element.

A lighting value BW of the surface element is calculated. This lighting value BW is a number greater than or equal to 0 and depends on angle θ between normal \vec{n} of the surface element and the given direction of illumination \vec{r}.

For each surface element of the breakdown, a given direction of viewing \vec{v} is also mirrored around normal \vec{n} of the surface element. Normal \vec{n}, direction of viewing \vec{v}, and mirrored direction of viewing \vec{s} are all in one plane. The angle between the normal and the direction of viewing is equal to the angle between the normal and the mirrored direction of viewing \vec{s}. Angle ρ between mirrored direction of viewing \vec{s} and direction of illumination \vec{r} is calculated. A highlight value GW of the surface element is calculated as a function value GF(ρ) of the given highlight function GF. Highlight value GW is greatest when mirrored direction of viewing \vec{s} is parallel to a direction of the strongest lighting intensity. In many cases, the direction of the strongest lighting intensity is equal to the given direction of illumination \vec{r}.

At least one brightness value HW is calculated for each surface element. Lighting value BW=HF(Θ) and highlight value GW=GF(ρ) are used for this. Lighting value BW and highlight value GF are combined into a brightness value HW of the surface element.

Using the surface model, the surface elements, and their brightness values, a three-dimensional computer-accessible display of the object is generated in such a way that the greater its brightness value HW, the brighter a surface element is displayed.

The surface elements of the surface model and thus the areas of the surface pointing away from the given direction of illumination also have a brightness value greater than 0 and are shown as being visible in the display in the method as recited in Claim 1 or Claim 6, because both the brightness function and the highlight function assume a value greater than 0 for each angle smaller than 180°. Since each surface element has a brightness value greater than 0, the illumination effect by diffuse daylight is imaged realistically. The display images the effect of beams of light striking the surface of the object from various directions, but preferably from above, in a realistic manner. This effect also occurs with natural daylight.

The method as recited in Claim 1 or Claim 6 therefore generates a realistic display of the object illuminated by diffuse light. The display is particularly realistic when the illumination has the property that the lighting intensity is rotationally symmetrical about the given direction of illumination. In the case when the illumination is caused by daylight, rotationally symmetrical lighting intensity, in particular in the case of an overcast sky, is provided with sufficient accuracy. CIE Draft Standard 011.2/E of 2002, available at http://www.cie-usnc.org/images/CIE-DS011 2.pdf, queried on Apr. 13, 2004, defines various types of daylights including the rotationally symmetrical types CIE 1, 3 and 5 as well as the “traditional overcast sky” listed as type 16, which had already been introduced by Moon/Spencer, loc. cit. in 1942 and was elevated to the level of CIE standard in 1996.

The method as recited as Claim 1 or Claim 6 yields a realistic three-dimensional display which gives a realistic impression of the geometric shapes of the object and shows a realistic simulation of the diffuse rotationally symmetrical illumination of the object. This realistic impression is advantageous in comparison with displays having artificial shading because the human visual system is able to correctly discern a shape from a shaded display only if the light is coming mainly or exclusively from one direction.

The method as recited in Claim 1 or Claim 6 differs from the known methods in that, among other things, it provides those areas of the surface that are visible from the direction of illumination as well as those areas that are not visible from this direction with a brightness value greater than 0. Therefore, even those areas of the surface facing away from the direction of illumination are also displayed.

This method does not require any special handling for areas of the surface model facing away from the light source—i.e., a handling which differs from the handling of those areas on the side facing the light source.

The method as recited in Claim 1 or Claim 6 does not require any preprocessing or post-processing of the surface model. Instead a ready-to-use display is automatically generated from a surface model that is available anyway. A breakdown into surface elements is often generated anyway, e.g., to subsequently perform a finite element simulation.

The method as recited in Claim 1 or Claim 6 does not require much computation complexity and is therefore rapid. It does not require any special computer for its execution. It is possible to predict exactly which computation steps are to be performed as soon as the surface model having the surface elements is available. A calculation of the normal, calculation of the angle between the normal and the given direction of illumination, and calculation of the function value are necessary for each surface element. Since the computation complexity is predictable, the method is real time capable, i.e., before using the method it is possible to check on whether or not a given upper limit for the time involved may be complied with. This property is important in particular for an interactive display. For an interactive display, a method is needed which generates and modifies a display as a function of user input. For example, as a function of user input, a new display from another direction of view, a detail enlargement, a display with stronger lighting or a different distribution of lighting or a display with an altered surface may be generated. In order for the response time to be accepted by the user, the method must rapidly generate a new display and comply with a predefined response time.

The method as recited in Claim 1 or Claim 6 generates a display without a hard illumination and without hard shadows. Such illuminations and shadows also do not occur in reality under diffuse light.

This eliminates the illumination simulation by multiple light sources. Therefore, the time required to adjust the illumination is greatly shortened. In known computer graphics methods, adjusting the parameters for a realistic display of the illumination takes almost as long as generating the surface model of the object to be displayed.

In addition, in the method as recited in Claim 6, the time for calculation of the computer-accessible three-dimensional display is also greatly reduced. This advantage is achieved because the method makes it unnecessary to generate the display of the illuminated object by simulating a superpositioning of multiple light sources. In particular, the restrictions resulting from the use of graphic cards in a computer has less effect here. The hardware functions limit the simulation of superpositioning because current graphic cards support a maximum of eight light sources. The known methods rapidly reach this limit and can no longer be implemented through hardware. To superimpose more than eight light sources using the known methods requires a software simulation which is slower by a factor of 10 to 100 than calculation by hardware.

A first and second direction of illumination of a first and second illumination of the object are predefined in the method as recited in Claim 12. The first direction of illumination is a direction from which the first illumination acts on the object. The second direction of illumination is a direction from which the second illumination acts on the object. In addition, a computer-accessible surface model of the object is predefined.

The method as recited in Claim 12 includes the following method steps:

Points of the given surface model are selected and used as pixels of the display to be generated.

For each selected pixel, a first light intensity of the pixel resulting from the first illumination of the object is calculated as a function of the first direction of illumination.

For each selected pixel, a second light intensity of the pixel resulting from the second illumination of the object is calculated as a function of the second direction of illumination.

For each selected pixel, a total light intensity of the pixel is calculated as a function of the first and second light intensities of the pixel.

The total intensity of each selected pixel is transformed into an electric input signal of the pixel processable by the video display unit.

A computer-accessible display of the physical object is generated. To do so, the selected pixels and the calculated input signals of the pixels are used. The display includes the selected pixels at the positions determined by the surface model.

This display having the selected pixels and the calculated input signals of the selected pixels is transmitted to the video display unit.

The video display unit shows the display, displaying each pixel with a display light intensity that is a function of the input signal.

The light intensity of the light source illuminating the object and the distance between this light source and the object are predefined in the method as recited in Claim 23. In addition, a computer-accessible surface model of the object is predefined.

The method as recited in Claim 23 includes the following method steps:

Points of the given surface model are selected and used as pixels in the display to be generated.

For each of these pixels, a first light intensity of the pixel resulting from the illumination of the object is calculated as a function of the light intensity of the light source and the square of the distance between the light source and the object.

For each selected pixel, the calculated light intensity is transformed into an input signal of the pixel processable by the video display unit.

A computer-accessible display of the physical object is generated. The selected pixels and the calculated input signals of these pixels are used for this. The display generated includes the selected pixels at their positions as predefined by the surface model.

This display having the selected pixels and the calculated input signals of the selected pixels is transmitted to the video display unit.

The video display unit shows the display, displaying each pixel with a display light intensity that depends on the input signal of the pixel.

The present invention differentiates a physical level and a coding level which is described below. According to the present invention, all calculations for generating the display are first performed in a physical space using physical quantities. Only then are the gamma behavior of the video display unit and the ambient lighting taken into account and the color codes necessary for triggering the video display unit are thus calculated.

On a physical level, the light intensities of the pixels are calculated. The calculations on the physical level simulate the physical reality when the object is illuminated. The method steps on the physical level do not depend on the particular video display unit and do not depend on the quantity of input signals processable by this video display unit in each case. In physical reality, the total light intensity of two superimposed light intensities is equal to the sum of these two light intensities. This is Grassmann's superposition principle. In physical reality, the light intensity produced by a light source on the surface of an object also decreases with the square of the distance between the object and the light source.

Since the calculations, e.g., superpositioning and decay behavior, are performed in a physical space, the physical laws are correctly taken into account without being distorted by compensation of the gamma behavior, for example.

The present invention ensures that the display generated will reflect in a physically correct manner the influence of the distance between the light source and the object. The influence of the light intensity of the light source decreases with the square of the distance between the object and the light source. This influence is correctly simulated by the method according to the present invention.

The calculations on the physical level may be performed with the required accuracy in each case, e.g., 4-bit, 8-bit, or 32-bit floating-point display.

In contrast, the method steps that take place on the coding level, namely transformation and the display on the video display unit, depend on the particular video display unit. On this coding level, it is only approximately true that the coded total light intensity of two superimposed light intensities is equal to the sum of the codings of these two light intensities because on the coding level the method steps are performed in the set of processable input signals.

This input signal set is generally discrete so it is made up of a finite number of different processable input signals. The correlation between the input signal and the light intensity with which a video display unit displays a pixel on the basis of this input signal is generally nonlinear. The physical reality would not be reflected correctly if the first light intensity of each pixel were first transformed into a first input signal and if the second light intensity were transformed into a second input signal and then if a total input signal were calculated as a sum of the first and second input signals.

As a rule, a lower precision is used in color coding than on the physical level, usually an 8-bit coding each for the red value, the green value, and the blue value. Since the compensation is performed first and therefore with a higher accuracy, banding (“rope effects”) at color transitions is prevented.

If the display shows the object in illumination by a diffuse light source, no hard light edges will occur. Hard light edges in the display do not conform to physical reality because in reality, diffuse (soft) light always occurs. The unrealistically hard light generated by the known illumination method of computer graphics, however, often leads to hard light edges. These light edges appear unrealistic and therefore are often undesirable. However, they are a necessary result of the known illumination methods.

These light edges are an example of how an error (illumination) in the known methods is concealed by another error (gamma): hard lighting with the wrong gamma appears soft and thus realistic. If only one error is eliminated, the result is inferior: hard lighting with correct gamma appears unrealistically hard. Only by eliminating both errors is improvement achieved: soft lighting with correct gamma yields soft light transitions and appears realistic.

In many known methods, the gamma behavior of a video display unit is regarded as a problem that must be compensated. An attempt is made to force the display light intensity to have a linear dependence on the particular input signal of a pixel. Thus there is a great advantage to the compensated gamma behavior according to the present invention: the gamma curve of a typical cathode ray tube is approximately inverse to the perception curve of the human eye. Therefore gamma behavior in particular results in a display that is “perceptually uniform.”

A correct method for taking into account the gamma behavior is also necessary in order to perform anti-aliasing without the roping effect. Aliasing is understood to refer to the effect whereupon almost horizontal lines on a video display unit are displayed using pixels in the form of stairsteps. Anti-aliasing suppresses this unwanted effect. This roping effect is described by Akenine-Möller/Haines, loc. cit., pp. 112-113. It results in a bundle of curves appearing like twisted cable on the video display unit.

This method makes it possible to perform gamma compensation independently of the transformation into an input signal. It is therefore possible to perform various gamma compensations for different areas of the surface. The known methods permit only a uniform gamma compensation of each pixel in the display. The present invention may be used, for example, for designing motor vehicles, [for] a graphic three-dimensional navigation system in a motor vehicle, for generating technical illustrations, for advertising and sales presentations, for computer games having three-dimensional displays, or in a driving simulator for training vehicle drivers, train engineers, captains of ships, or airplane pilots. In all these applications it is important to generate a realistic display.

An exemplary embodiment of the present invention is described in greater detail below on the basis of the accompanying figures.

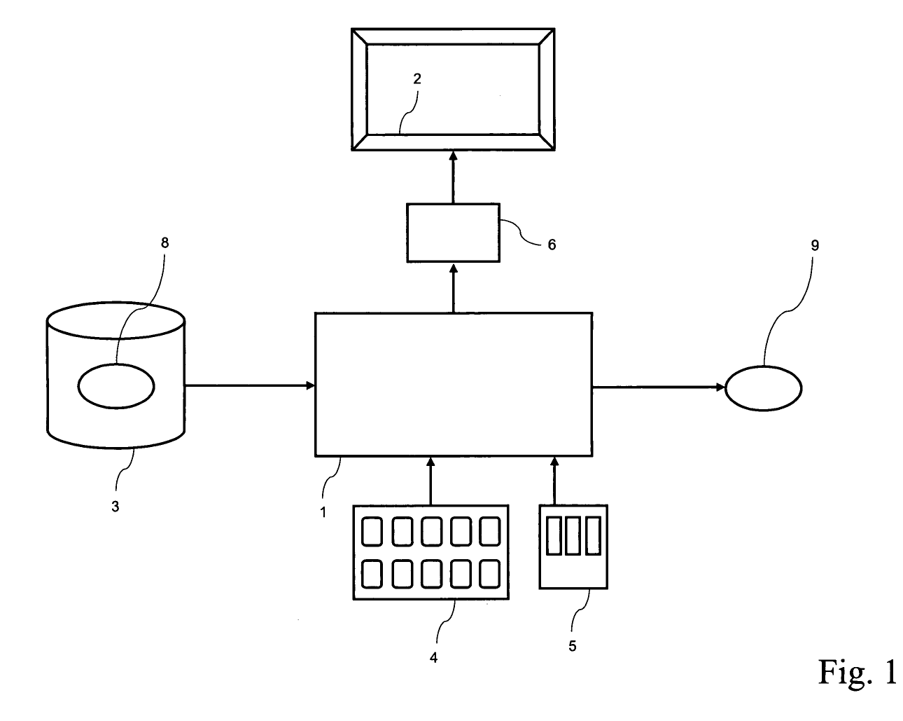

FIG. 1 shows an exemplary architecture of a data processing system for performing the method;

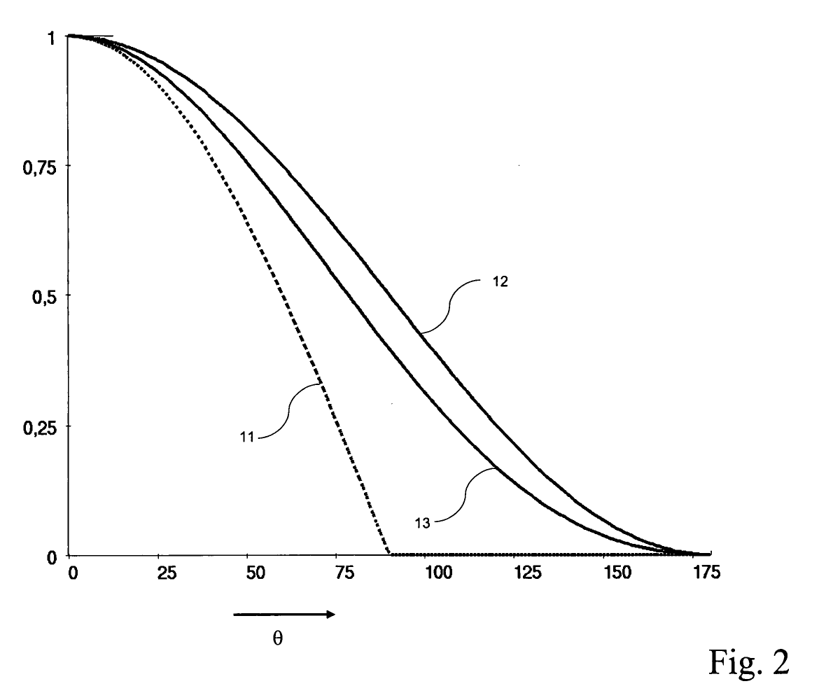

FIG. 2 shows some examples of brightness functions;

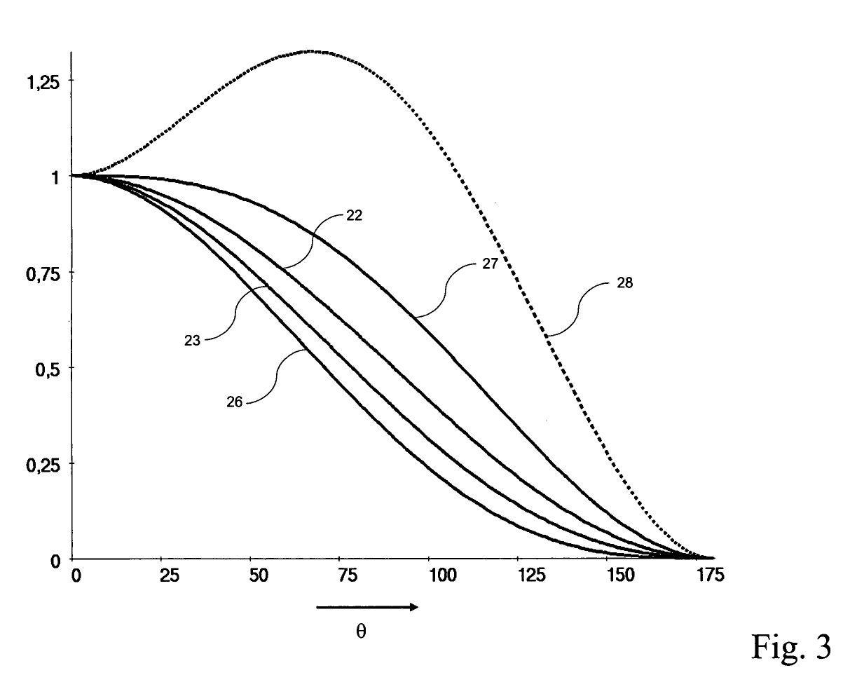

FIG. 3 shows some examples of brightness functions which are affine linear combinations of brightness functions from FIG. 2;

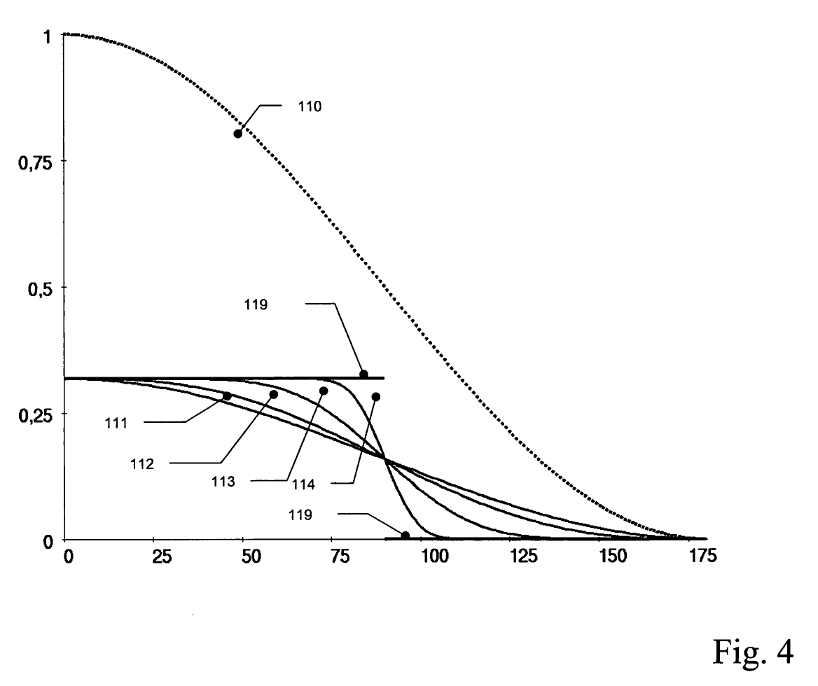

FIG. 4 shows the light distribution function, brightness function, and highlight functions for the isotropic sky;

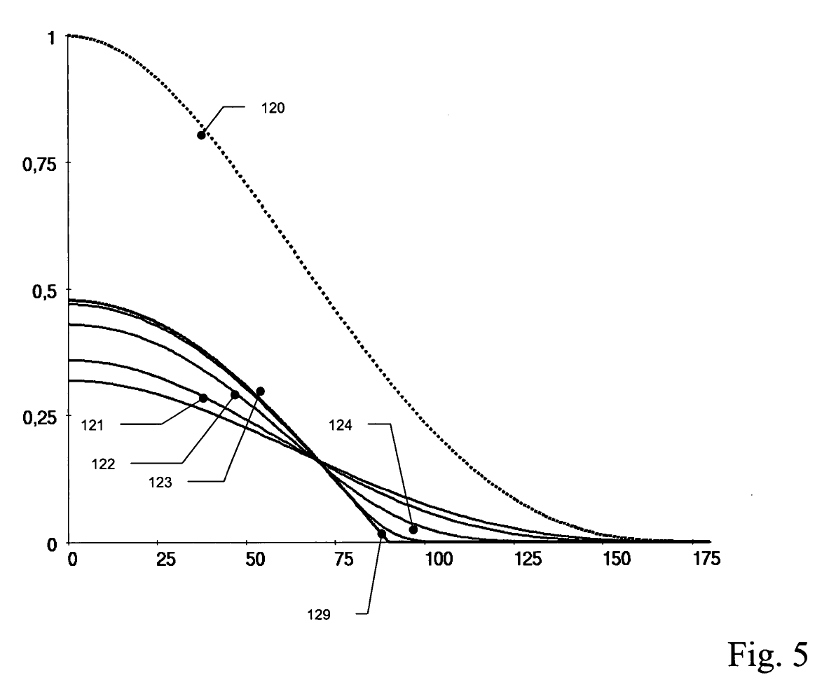

FIG. 5 shows the light distribution function, brightness function, and highlight functions for the cosine-shaped sky;

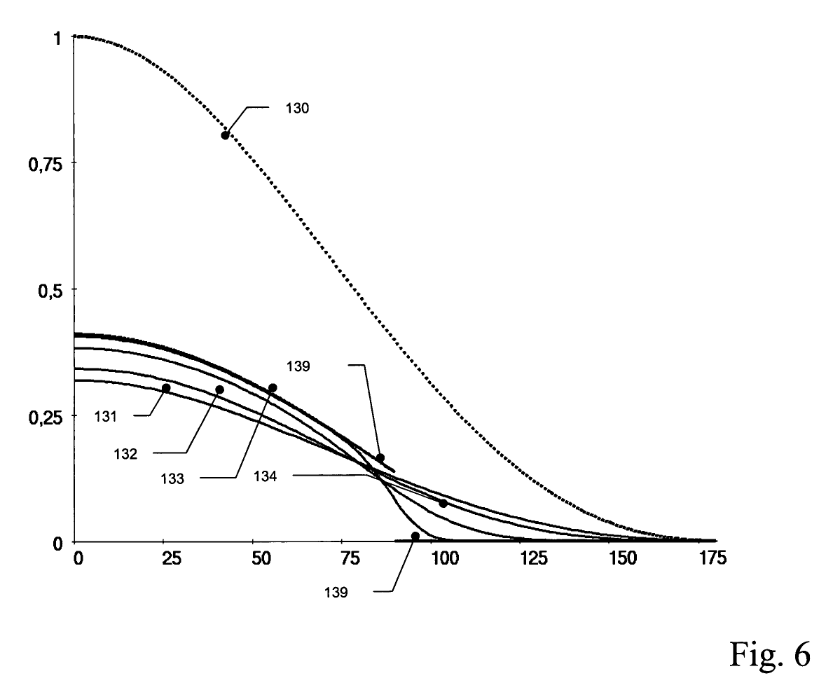

FIG. 6 shows light distribution function, brightness function, and highlight functions for the traditional overcast sky;

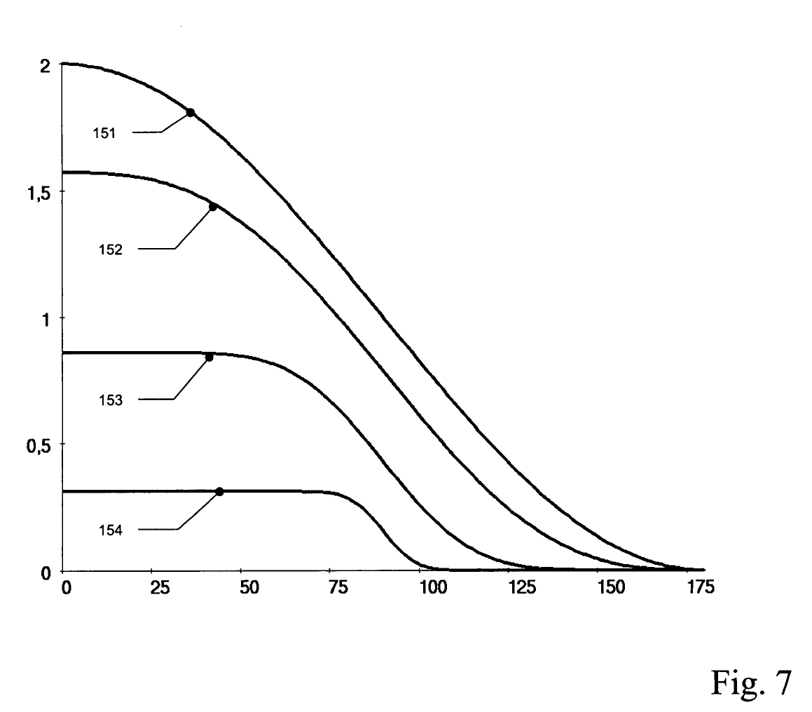

FIG. 7 shows graphs of the ICOSN function;

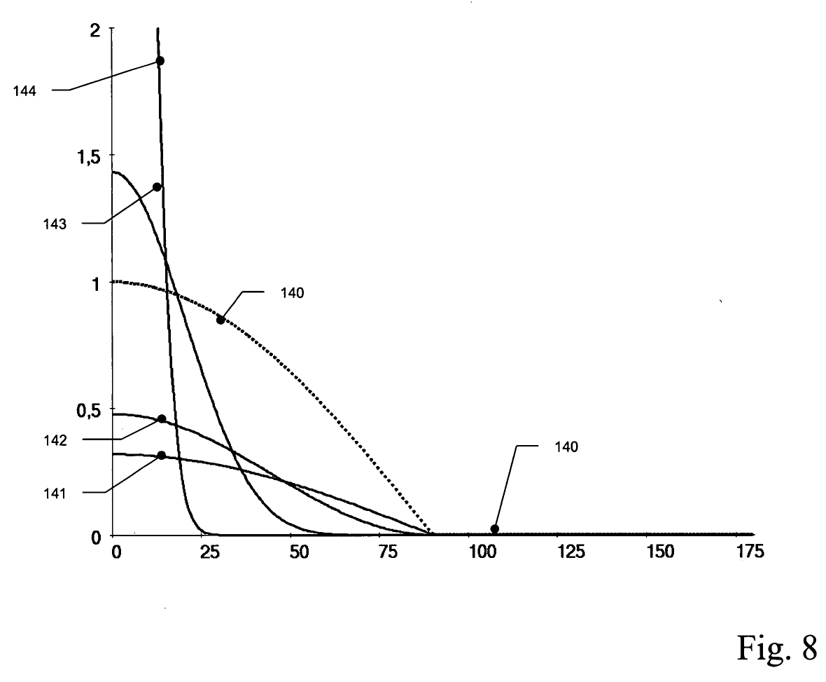

FIG. 8 shows the brightness function and some highlight functions of a punctiform source;

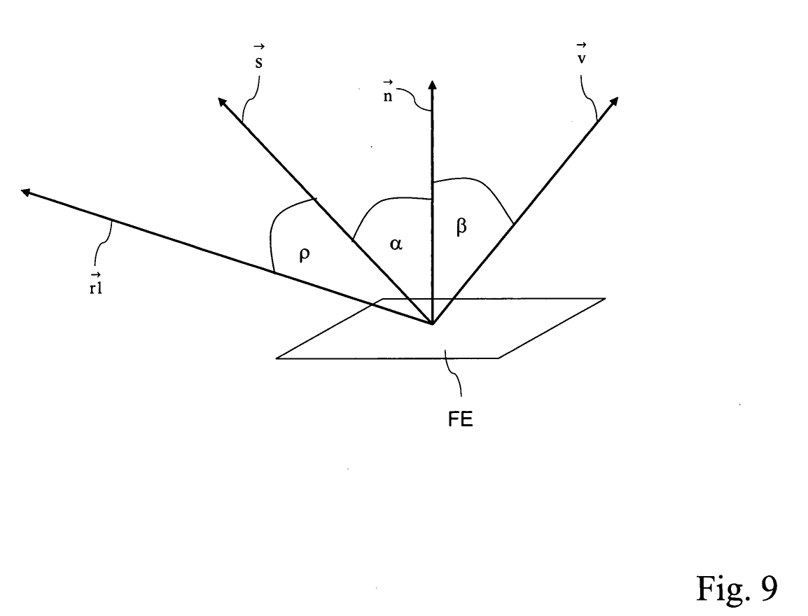

FIG. 9 shows the calculation of the angle between the mirrored direction of viewing vector and the direction vector;

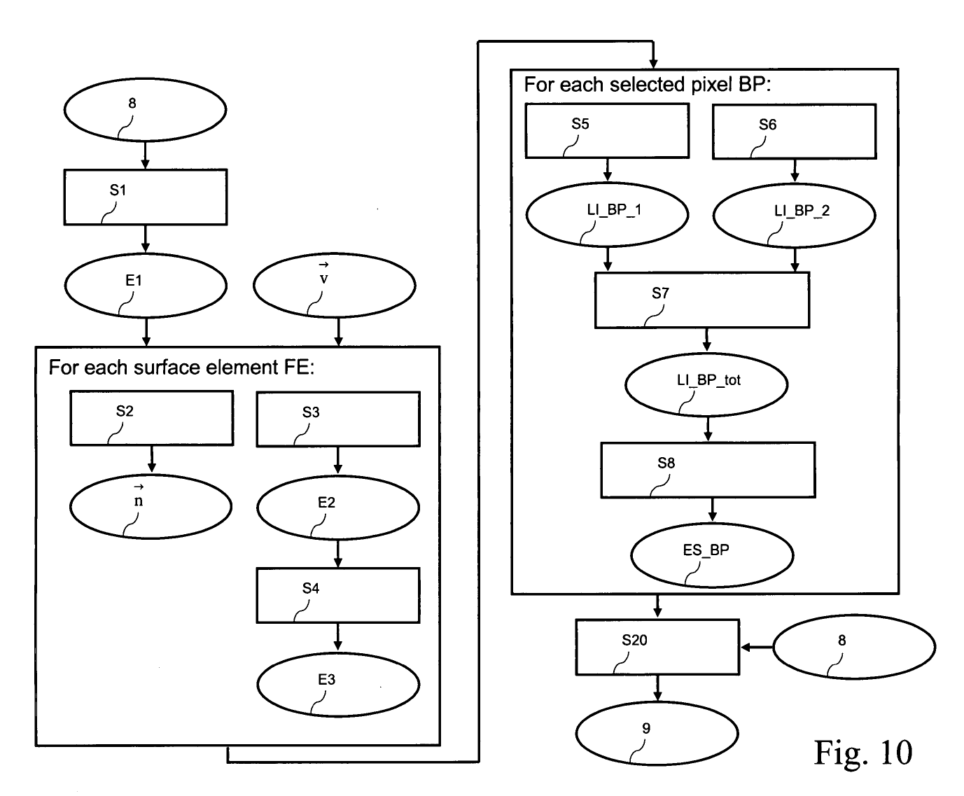

FIG. 10 shows a flow chart for the method illustrating the generation of the display;

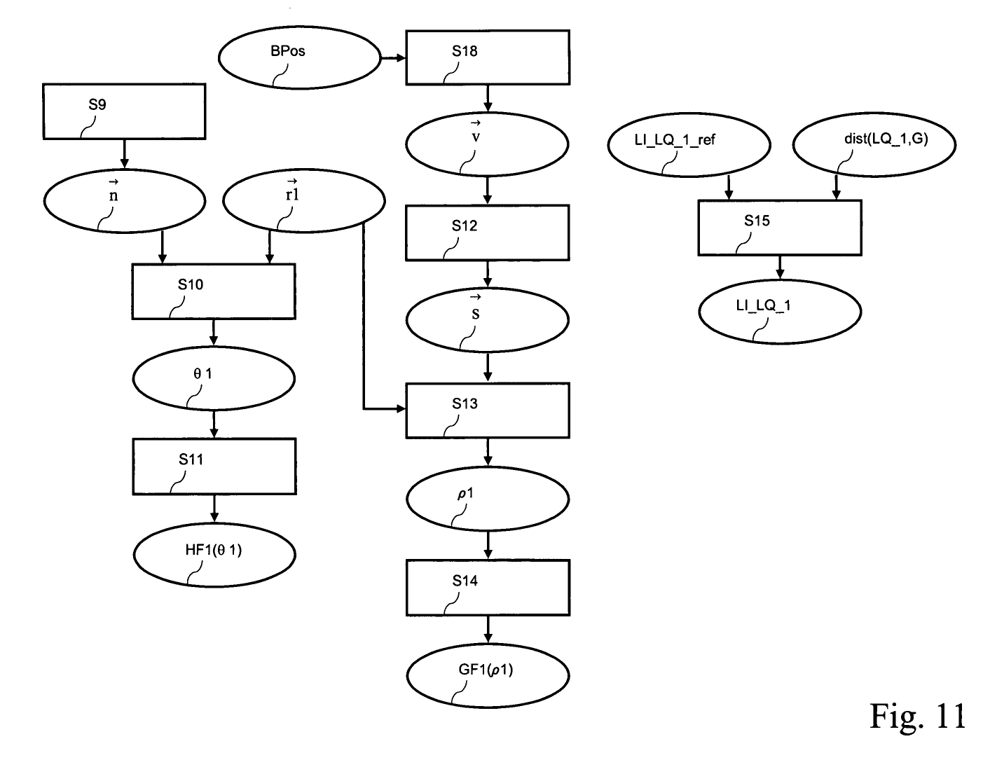

FIG. 11 shows a detail of the flow chart from FIG. 10, calculation of the first color hue light intensity;

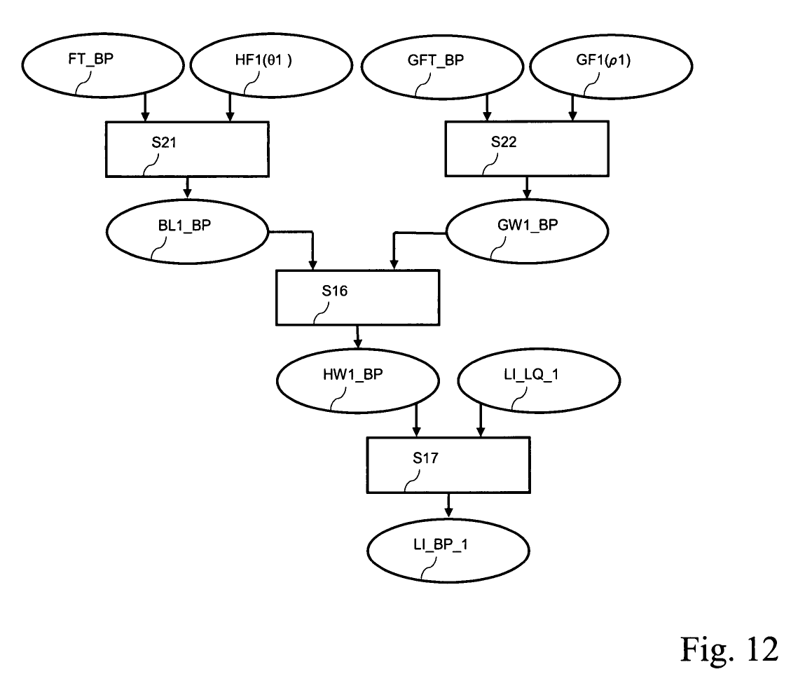

FIG. 12 shows the continuation of the flow chart from FIG. 11;

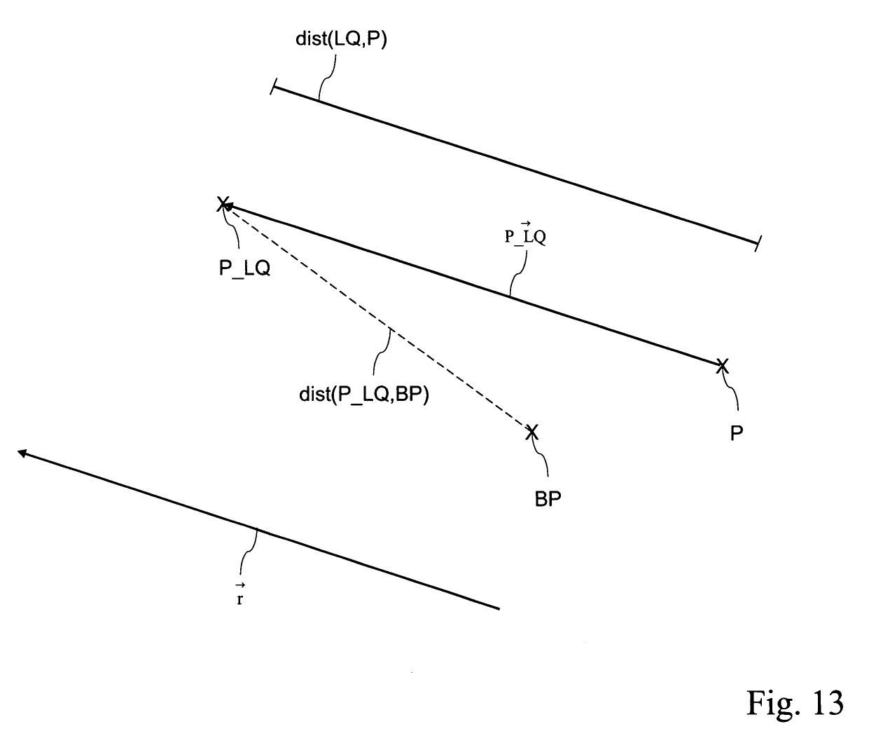

FIG. 13 shows the calculation of the distance between a punctiform source and the illuminated object;

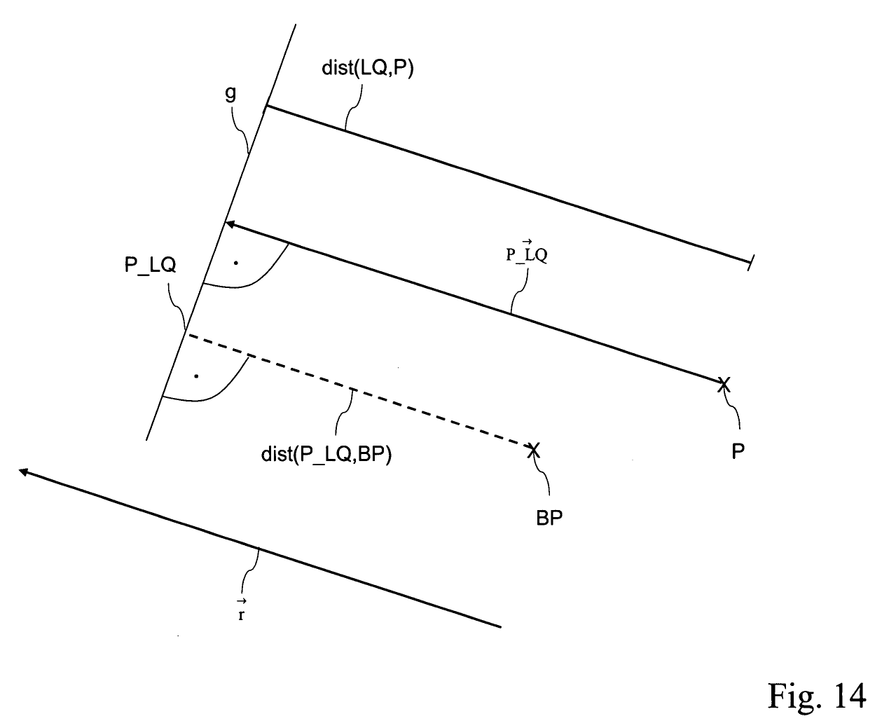

FIG. 14 shows the calculation of the distance between a spatially extensive light source and the illuminated object;

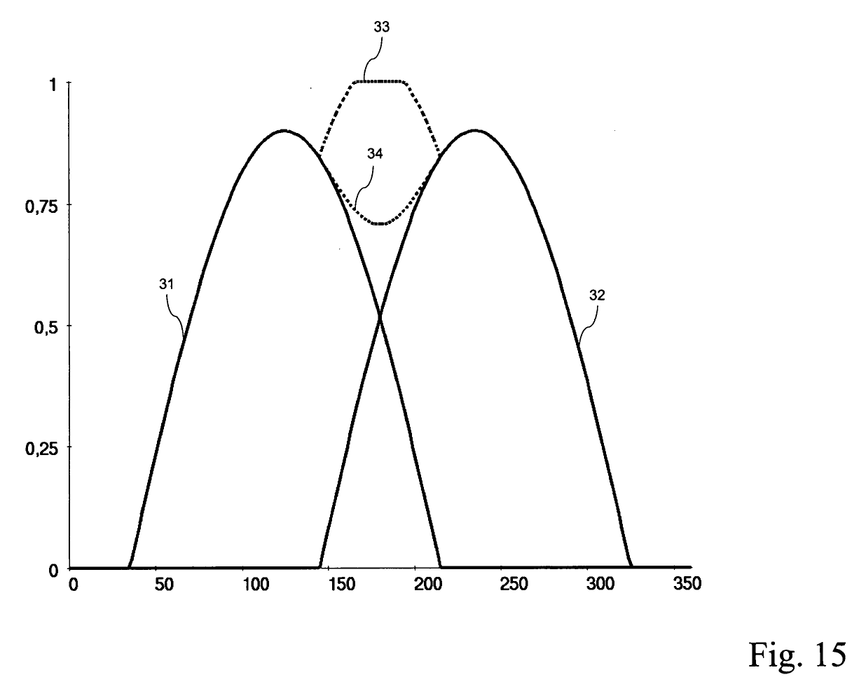

FIG. 15 shows the superimposing of two illuminations on the example of a ball;

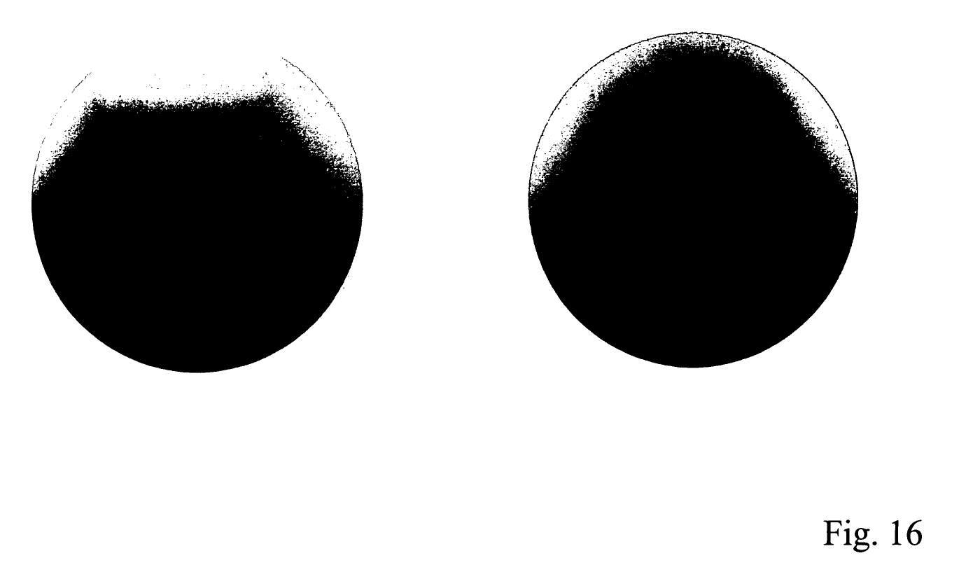

FIG. 16 shows the resulting displays.

The exemplary embodiment is based on an exemplary application of the method for designing motor vehicles. In this exemplary embodiment, the object is a motor vehicle or a part of a motor vehicle. This method generates a display showing how the vehicle appears when illuminated by at least one light source. In this exemplary embodiment, the light source is preferably diffuse light originating from daylight.

FIG. 1 shows an exemplary architecture of a data processing system for performing the method. This data processing system includes the following components in this example:

a computer unit 1 for performing calculations,

a video display unit 2 designed as a cathode ray tube video display unit,

a data memory 3 to which computer unit 1 has reading access via an information relaying interface,

a first input device in the form of a DV mouse 4 having three buttons,

a second input device in the form of a keyboard 5 having keys and

a graphic card 6 which generates the input signals for video display unit 2.

Video display unit 2 is a physical object due to the fact that it displays a display made up of pixels having different light intensities. The light intensity with which the video display unit displays a pixel depends on an input signal for this pixel.

Video display unit 2 is capable of processing an input signal and converting it into a light intensity only when the input signal is in a predefined quantity of processable input signals. For example, the input signal is an RGB vector (RGB=red-green-blue).

A computer-accessible surface model 8 of the object, i.e., the motor vehicle or the component of the vehicle and a computer-accessible description of the lighting of this object, are stored in data memory 3.

Surface model 8 describes at least approximately the surface of the motor vehicle as that of the three-dimensional object. This model includes all characteristics of the motor vehicle visible from the outside, but not its interior. This surface model 8 is generated for example from a computer-accessible three-dimensional design model (CAD model). Surface model 8 may instead be generated by scanning a physical exemplar or a physical model if such is already available.

Surface model 8 is broken down into a large quantity of surface elements. The surface elements are preferably in the form of triangles, but quadrilaterals or other surfaces are also possible. For example, the surface of surface model 8 is interconnected so that finite elements in the form of surface elements are obtained. The method of finite elements is known, for example, from “Dubbel-Taschenbuch für den Maschinenbau” [Dubbel's Handbook for Mechanical Engineering], 20^{th} edition, Springer-Verlag, 2001, C 48 to C 50. A certain quantity of points known as nodes is defined in surface model 8. The finite elements are the surface elements whose geometries are defined by these nodes.

Surface model 8 is generated by spline surfaces, for example. Surface model 8 is preferably broken down into surface elements in the form of triangles with the help of tessellation, which involves breaking down these spline surfaces into triangles.

Efficient methods for tessellation are described in Akenine-Möller/Haines, loc. cit., pp. 512 ff.

For each of these surface elements, at least one normal vector \vec{n} is calculated as the normal. This normal vector \vec{n} is perpendicular to the surface element and points outward away from surface model 8. Each normal vector \vec{n} is normalized so that ∥\vec{n}∥=1.

A first embodiment of this breakdown provides for surface model 8 to describe the surface of the object to be displayed with the help of spline surfaces. The surface elements are generated, e.g., by tessellation of these spline surfaces. As a rule, these surface elements are in the form of triangles. These normal vectors of these surface elements are calculated as the cross-product (vector product) of the partial derivatives.

A second embodiment does not presuppose that the surface of the object is described by spline surfaces. This second embodiment may also be applied when surface model 8 has been obtained empirically, e.g., by scanning a physical model. These surface elements are preferably triangles. Each normal vector \vec{n} of a triangular surface element is calculated from these triangles in such a way that it is perpendicular to the plane described by the triangle, or a normal vector for a common corner point of several triangles is calculated as the mean value of the normal vectors of the triangles meeting at the corner point. Methods for determining the normal vectors of triangular networks and for processing for the graphic display are described by T. Akenine-Möller/Haines, loc. cit., pp. 447 ff.

The normal vectors preferably point outward away from surface model 8. This orientation can always be achieved with an orientable surface or with a surface model 8 of a solid body. If necessary, a direction of the normal vectors is defined at one point and then the normal vectors of adjacent points are rotated successively.

The calculation of the normal vectors is performed once. It supplies a normal vector for each surface element, e.g., for each corner point of the breakdown. As long as neither surface model 8 nor the breakdown into surface elements is altered, the calculation need not be repeated. In particular, it is not necessary to recalculate the normal vectors when one of the two directions of illumination or the direction of viewing which is described below has been altered, when a display with altered lighting is to be calculated, or when a lighting intensity or a color hue of the illumination or the object has been altered.

In this exemplary embodiment, a first direction of illumination \vec{r1} is given by a vector pointing from surface model 8 in the direction of the first light source. For example, the first light source is a diffuse light source, e.g., daylight with a sky that is at least partially overcast. The intensity of the illumination is preferably rotationally symmetrical with respect to an imaginary axis of rotation through the object. First direction vector \vec{r1} in this embodiment is on the axis of rotation of the rotationally symmetrical illumination. For example, the direction of illumination is given by a direction vector which points away from the surface model and is situated on the axis of rotation. First direction vector \vec{r1} thus points away from the object in the direction of the light source, e.g., in the direction of the sun or the zenith. Since there are two direction vectors of the same length situated on the axis of rotation, the vector pointing in the direction of the half-space from which more light acts on the object is preferably selected. For example, direction vector \vec{r1} points in the direction of the zenith, i.e., perpendicularly upward from the earth's surface.

The second illumination in this exemplary embodiment is a punctiform light source or a directional light source, e.g., an artificial light source. Such punctiform light sources or directional light sources are described, for example, by Akenine-Möller/Haines, loc. cit., pp. 67 ff. A second direction vector \vec{r2} for this second light is also given. This second direction vector \vec{r2} points in the direction of the strongest lighting intensity of the second light source. If the second light source is the sun—not overcast by clouds—the second direction vector \vec{r2} points in the direction of the sun, which is assumed to be at an infinite distance. Both direction vectors are normalized, i.e., ∥\vec{r1}∥=1 and ∥\vec{r2}∥=1.

Pixels of the surface elements are selected. Display 9 to be generated includes these pixels and displays each with a calculated color hue and a calculated light intensity.

A normal vector \vec{n} is calculated for each selected pixel. If the pixel is in the interior of the surface element, the normal vector of the surface element, for example, is used as normal vector \vec{n} of the pixel. If the selected pixel is a corner point of multiple surface elements, then preferably an averaged normal vector is calculated from the normal vectors of the adjacent surface element and used as normal vector \vec{n} of the pixel. The sum of all normal vectors of the adjacent surface elements is calculated for this purpose and the sum is preferably normalized to length 1.

For each selected pixel, the cosine cos(θ1) of angle θ1 between normal vector \vec{n} of the pixel and the given first direction vector \vec{r1} to the diffuse light source is calculated by the scalar product, specifically according to the following formula:

$$cos ( θ 1 ) = \frac{〈 \vec{n} , \vec{r 1} 〉}{‖ \vec{n} ‖ \cdot ‖ \vec{r 1} ‖} .$$

Both normal vector \vec{n} as well as first direction of illumination vector \vec{r1} are preferably normalized to length 1 so that: cos(θ1)=<\vec{n}, \vec{r1}>.

Similarly cosine cos(θ2) of angle θ2 between normal vector \vec{n} to the surface element and the predefined second direction vector \vec{r2} to the punctiform or directional light source is calculated, i.e., according to the formula:

$$cos ( θ 2 ) = \frac{〈 \vec{n} , \vec{r 2} 〉}{‖ \vec{n} ‖ \cdot ‖ \vec{r 2} ‖} = 〈 \vec{n} , \vec{r 2} 〉 .$$

In this embodiment, a difference angle η which is between 0° and 90° is also given. By using difference angle η, the method generates a realistic display 9 of the vehicle for the case when the vehicle is illuminated only partially, e.g., because it is in a gorge and the sky extends only to angle η above the horizon. In reality, this results in individual areas of the surface remaining dark. By varying difference angle η, display 9 may be adapted to different depths of the gorge and/or height of the sky above the horizon.

In one embodiment, the diff-use light originates from a spatially extensive illumination, the lighting intensity of which is rotationally symmetrical to the given direction of illumination. One example is an illumination by daylight with an overcast sky where the direction of illumination points in the direction of the zenith, i.e., in the direction perpendicularly upward from the earth's surface. In this embodiment, the sky illuminates from above (only from directions above the horizon) and is assumed to be rotationally symmetrical.

The spatially extensive illumination is broken down into illumination surface elements. Because of the rotational symmetry of the illumination, the brightness of such an illumination surface element is a function only of angle between the vector of the object to the illumination surface element and the given direction vector which points in the direction of the direction of illumination away from the surface and lies on an axis of rotation of the rotationally symmetrical illumination. In particular in the case of illumination by diffuse daylight, the lighting intensity below the horizon, i.e., for angles ζ greater than 90°, is equal to 0. In this embodiment the brightness function is calculated by integrating the light distribution function LVF of the rotationally symmetrical illumination. Because of the rotational symmetry, LVF=LVF(ζ), where ζ is the angle introduced in the preceding paragraph. Lighting intensity LI striking a surface element of the surface model is calculated by integrating the area of the spatially extensive illumination which is visible from the surface element. Lighting intensity LI depends on a normal vector \vec{n} to the surface element. The normal vector here is normalized to a length of one, i.e., ∥\vec{n}∥=1.

In particular for real time applications, the influences of other objects, e.g., transparency, shadows and reflection, are disregarded and only the particular surface element and the at least one light source are taken into account. Incident lighting intensity LI depends only on normal vector \vec{n} normalized to ∥\vec{n}∥=1 to the surface element.

Therefore, the lighting intensity is calculated according to the formula:

$$LI = LI ( \vec{n} ) = {\int \int }_{\vec{1} ∈ Ω} LVF ( ( \vec{1} ) ) \vec{n} \cdot \vec{1} ⅆ Ω .$$

Integration range Ω is the average of the upper hemisphere having the positive normal space of the surface element and has the shape of a spherical digon (surface between two great circles); \vec{l} is the (normalized) direction vector to the sky element and dΩ is the surface element of integration to the sphere. Scalar product \vec{n}·\vec{l} describes the diffuse reflection on a matte surface according to Lambert's law.

If light distribution function LVF is a function only of the cosine of angle ζ, then LVF(ζ)= L̅V̅F̅[cos(ζ)]. Lighting intensity LI is then a function only of angle θ between the normal vector and the direction vector. Lighting intensity LI=LI(θ) is calculated for a surface element using suitable coordinates. These coordinates are preferably spherical polar coordinates (η, φ). The polar coordinates are preferably oriented in such a way that the given direction vector and the normal vector lie on the equator (θ=0) and the given direction vector additionally lies on the 0-meridian (φ=0). In that case, cos(ζ)=cos(φ)·cos(θ). If angles θ, θ, and Φ are given in arc dimensions, the lighting intensity is then calculated according to the formula:

$$LI ( θ ) = {\int }_{φ = θ - \frac{π}{2}}^{\frac{π}{2}} {\int }_{ϑ = - \frac{π}{2}}^{\frac{π}{2}} \overline{LFV} [ cos ( φ ) cos ( ϑ ) ] \cdot {cos}^{2} ( ϑ ) \cdot cos ( φ - θ ) ⅆ ϑ ⅆ φ .$$

This integral is at least numerically calculable. In many cases it may even be solved explicitly, preferably using a computer algebra program. The result may also be saved in the form of a table having interpolation points or as an environment map. An environment map is known for example from Akenine-Möller/Haines, loc. cit., pp. 163 ff.

This integral reaches a maximum value LI_max>0. The integrated lighting intensity normalized with

$$LI\_max , i . e . , HF ( θ ) = \frac{LI ( θ )}{LI\_max} ,$$

is used as brightness function HF of the sky.

At least one brightness function HF is predefined for the method and is calculated as described above, for example. The concept of this function is described in “Dubbel-Taschenbuch für den Maschinenbau” [Dubbel's Handbook for Mechanical Engineering], 17^{th} edition, Springer-Verlag, 1990, A 4. A function assigns one function value to each argument from a predefined set of arguments. The brightness function has angles from 0° to 180° (inclusive) as the set of arguments.

The at least one given brightness function HF has the angles from 0° to 180° (inclusive) as the set of arguments. It assigns function value 0 to argument 180° and assigns one function value greater than or equal to 0 to each argument less than 180°. The image set, i.e., the quantity of function values, is thus the set of real numbers greater than or equal to 0. The at least one brightness function describes the effects of an illumination on an illuminated object.

Brightness function HF is preferably monotonically descending, i.e., when an angle θ1 is smaller than an angle θ2, HF(θ1) is greater than or equal to HF(θ2). However, it is also possible for brightness function HF to first be monotonically increasing to a maximum—starting from the argument 0°—and then falling monotonically again.

Brightness function HF is preferably normalized to the interval from 0 to 1. This means that each function value of the brightness function is less than or equal to 1 and at least one function value is equal to 1.

The brightness function is preferably a function of the cosine of the angle. It is a function only of the cosine but not the angle itself. In this case the angle need not be calculated but instead only the cosine of the angle is calculated. The cosine of angle a between two vectors \vec{a} and \vec{b} is [calculated] as described above, preferably with the help of scalar product \vec{a} \vec{b} according to the formula

$$cos ( α ) = \frac{\vec{a} \vec{b}}{‖ \vec{a} ‖ ‖ \vec{b} ‖}$$

Angle α itself need not be calculated. This simplifies and accelerates the calculation of the function value of the frequency function.

It is possible for a single brightness function to be given, describing both the effect of the first illumination as well as the effect of the second illumination on the light intensity of a point on the surface of the object. In this exemplary embodiment, however, two different brightness functions HF1 and HF2 are given. First brightness function HF1 describes the effects of the illumination of the object by the diffuse first light source. The second brightness function HF2 describes the effects of the illumination by the punctiform or directional second light source.

FIG. 2 shows as an example multiple such brightness functions. Dashed line 11 shows the graphs of a brightness function HF2 for the punctiform or directional light source. This brightness function HF2 has the form HF2(θ)=max[cos(θ), 0], where θ denotes the angle between normal vector \vec{n} and second lighting vector \vec{r2}. It is clear from the formula as well as the shape of the curve in FIG. 2 that for angles greater than 90°, brightness value HF2(θ) is equal to 0. Furthermore, brightness function HF2 has a discontinuity at θ=90°.

FIG. 2 shows two brightness functions HF1 drawn in solid lines 12 and 13, each having the following properties:

They assign a number between 0 and 1 to each angle between 0° and 180°.

They assign a value of 1 to an angle of 0° and assign a value of 0 to an angle of 180°.

They are monotonically falling.

They are smooth, i.e., without discontinuities. This embodiment causes the brightness to vary over the surface model 8 and thus over the display 9 to be generated in a particularly soft manner and it prevents a hard and unrealistic light edge from being perceived. A light edge is generated only when there is a discontinuity or an edge in the surface of surface model 8 in which case it is realistic and therefore not problematical.

Curve 12 describes the brightness function of the isotropic sky which is defined in type 5 (“sky of uniform luminance”) of the standard CIE Draft Standard 011.2/E. This standard of 2002 is available at http://www.cie-usnc.org/images/CIE-DS011 2.pdf, queried on Apr. 13, 2004 and defines various types of illumination from the sky, including the rotationally symmetrical types CIE 1, 3, and 5, as well as the “traditional overcast sky” listed as type 16. Curve 12 shows the graphs of brightness function HF1_iso with

$$HF 1 \_iso ( θ ) = \frac{[ cos ( θ ) + 1 ]}{2} .$$

Curve 12 in FIG. 2 is a function only of the cosine of angle θ but not of angle θ between normal \vec{n} and the particular lighting vectors \vec{r1} and \vec{r2} themselves.

Curve 13 in FIG. 2 shows graphs of brightness function HF1_trad of the “traditional overcast sky.” A mathematical model of this “traditional overcast sky” was introduced by Moon/Spencer, loc. cit. in 1942. The “traditional overcast sky” was elevated to the level of a CIE standard in 1996. Its brightness function HF1_trad is of the following form:

$$HF 1 \_trad ( θ ) = \frac{3}{14} + \frac{4}{7 π} sin θ + \frac{1}{14} ( 11 - \frac{2}{45} θ ) cos θ .$$

According to another embodiment of the brightness function, an affine linear combination HF1_aff of two of brightness functions HFa and HFb just described is used, i.e.,
HF1_{—}aff(θ)=c·HFa(θ) +(1−c)·HFb(θ),

where coefficient c is selected in such a way that new brightness function HF1_aff is greater than or equal to 0 for all angles θ between 0° and 180°. A whole set of brightness functions may be described in this way, averaging between the brightness function of the isotropic sky and the brightness function of the “cosine sky.”

If the brightness function of the isotropic sky is used for HFa and the brightness function of the traditional overcast sky is used for HFb, the affine linear combination results in the brightness function

$$HF 1 \_aff ( θ ) = \frac{c}{2} ( cos ( θ ) + 1 ) + ( 1 - c ) ( cos ( θ ) + \frac{sin ( θ )}{π} - \frac{θ}{180} cos ( θ ) )$$

with a factor c>0 which ensures that HF1_aff(θ)>0. Angle θ is also measured in degrees in this formula. In the case of a factor c>1, it may happen that the brightness function initially increases monotonically and then drops again. This correctly simulates reality because in the case of diffuse daylight as illumination, the direction to the zenith is on the axis of rotation and is the first direction of illumination but is not in all cases the direction of the strongest light intensity. With a clear sky, the light intensity in the zenith direction is usually lower than that in a shallower direction away from the sun.

For c= 3/7, this embodiment transitions to the brightness function of the “traditional overcast sky,” i.e., to

$$H F ( θ ) = \frac{3}{14} + \frac{4}{7 π} sin θ + \frac{1}{14} ( 11 - \frac{2}{45} θ ) cos θ .$$

FIG. 3 shows a few examples of such brightness functions, which are affine linear combinations of brightness functions from FIG. 2. Curve 26 shows the brightness function for c=0; curve 27 shows the brightness function for c=2, and curve 28 shows the brightness function for c=5. For comparison purposes, curve 22 for the “isotropic sky” (c=1) and curve 23 for the “traditional overcast sky” (c= 3/7) from FIG. 2 are also shown.

Curve 28 (c=5) is not monotonic and assumes function values greater than 1. Its maximum is at approx. 77°. In combination with a conventional directional light source, e.g., the sun, the brightness function having curve 28 gives a realistic impression of the object, e.g., on a clear sunny day. To allow better comparison and to allow conventional normalization to be used in calculating the brightness of spaces, it also holds that HF28(0)=1 for brightness function HF28 having curve 28.

According to a refinement of the exemplary embodiment, a varied brightness function vHF1, which is defined with the help of difference angle η described above, is to be used as the first brightness function. Let HF1 be a first brightness functions as just described for the first illumination. According to one embodiment, varied brightness function vHF1 is defined using first brightness function HF1 according to the following formula:

$$\begin{matrix}vHF 1 ( θ ) = H F 1 ( \frac{180}{180 - η} \cdot θ ) , & if 0 \leq θ < 180 - η \\ vHF 1 ( θ ) = 0 , & if 180 - η \leq θ \leq 180 ,\end{matrix}$$

where θ again denotes the angle between normal \vec{n} and particular direction of illumination \vec{r1} or \vec{r2}.

According to an alternative embodiment, varied brightness function vHF1 is described by the following formula:

$$vHF 1 ( θ ) = \frac{max \{ cos ( θ ) + cos ( η ) , 0 \}}{1 + cos ( η )} .$$

This formula represents a continuous transition between a completely diffuse illumination (η=0) and a directional light source at the zenith (η=90).

The effect of the highlights described above on display 9 of the object to be generated is preferably also taken into account. This effect depends on given direction of viewing \vec{v} to the object.

In addition, a direction of viewing \vec{v} is predefined. For example, this direction of viewing is predefined directly. Or a viewing point is predefined, e.g., the point at which a viewer or a camera is situated. Direction of viewing \vec{v} is calculated as the direction from the viewing point to the object.

Display 9 to be generated shows the object from this given direction of viewing \vec{v}. In the case of a perspective display via central projection, direction of viewing \vec{v} is the direction from the center of the central projection to an area on the surface of the object to be displayed. This direction of viewing \vec{v} may depend on and vary with the particular point on the surface of the object. Therefore, in the case of a central projection, a direction of viewing \vec{v} is calculated for each selected pixel.

There is preferably a determination of which surface elements of surface model 8 are visible from this direction of viewing \vec{v} and are therefore displayed in display 9 to be generated. Pixels are selected only from such-surface elements. This avoids performing unnecessary calculations—namely, calculations for pixels not visible in display 9.

Preferably at least one pixel is selected for each visible surface element. For example, the corners of each visible surface element are selected.

The preferred embodiment which takes into account the highlights produced by the illumination is described below. An ideal matte surface reflects incident light uniformly in all directions and behaves according to Lambert's law. An ideal reflective surface reflects an incident beam of light in one direction. According to the law of reflection, the angle of incidence for an ideal reflective surface is equal to the angle of reflection. A real surface does not behave like an ideal matte surface or like an ideal reflective surface. Instead, a glossy surface also scatters the reflected light. As a result, the beams of light reflected back are distributed around the direction of the ideal reflection. Thus, a bundle of reflected beams is formed from one incident beam of light, and an entire gloss spot is formed from a bundle of parallel incident beams. The method according to the present invention generates this gloss spot in a realistic manner and with a low degree of computation complexity.

A real surface scatters a portion of the incident light as matte scattering and reflects another portion as highlights. The method according to the present invention simulates this process in a realistic manner, taking into account both the matte and glossy components of a surface.

Highlights produced on the surface of an object being displayed due to the diffuse rotationally symmetrical illumination are imaged in a realistic manner in the display generated. This results mainly from the fact that even areas facing away from the direction of illumination may be provided with highlights, and therefore angle ρ between the mirrored direction of viewing and the direction of illumination is greater than 90°.

The spatially extensive illumination illuminates the object from a hemisphere HS², i.e., from the part of the sphere delineated by a plane in space, i.e., in a “half-space.” In the case of illumination by daylight, this plane is the earth's surface, which is assumed to be approximately flat.

Let \vec{r} be a direction vector parallel to the direction of illumination and pointing away from the surface model in the direction of the rotationally symmetrical illumination striking the object. The illumination is rotationally symmetrical with respect to this direction vector \vec{r}. Let \vec{v} be a vector parallel to the direction of viewing of the display to be generated and pointing outward away from the surface model. The spatially extensive illumination is described by a light distribution function LVF which is defined on the hemisphere. Hemisphere HS² is broken down into illumination surface elements. For each illumination surface element dΩ, let \vec{l} be a direction vector pointing away from the object to illumination surface element dΩ. The illumination originating from this illumination surface element is then equal to LVF(\vec{l})·dΩ. Let \vec{n} be a normal vector for a surface element of the surface model pointing outward in relation to the surface model. Direction of viewing vector \vec{v} is mirrored symmetrically to normal vector \vec{n}. The ideal mirrored direction of viewing vector \vec{v} is referred to as \vec{s}. All highlights reflected by the surface element in the direction of \vec{v} are calculated as a sliding average of the illuminance described by LVF around ideal reflective direction of viewing \vec{s}.

The brightness of such an illumination surface element depends only on angle ζ=ζ(\vec{l}) between vector \vec{l} of the object to the illumination surface element and given direction vector \vec{r} because of the rotational symmetry of the illumination. In particular, in the case of illumination by diffuse daylight, the illuminance below the horizon, i.e., for angles ζ>90°, is equal to 0.

In addition, a rotationally symmetrical highlight control function GSF is predefined. This depends only on angle σ=σ(\vec{l}, \vec{s}), which is the angle between vector \vec{l} to the illumination surface element and mirrored direction of viewing vector \vec{s}. Highlight scattering function GSF describes how an incident beam of light is scattered in reflection and conversely from which directions beams of light reflected in the direction of viewing have originated.

Highlights reflected entirely by the surface element depend on direction of viewing vector \vec{v} and are calculated according to the formula:

$$GL ( {v}^{->} ) = {\int \int }_{{1}^{->} ∈ Ω} LVF ( ( {1}^{->} ) ) \cdot GSF ( σ ( {1}^{->} , {s}^{->} ) ) ⅆ Ω .$$

With an exact calculation, integration range Ω is the part of the sky visible from the surface element, i.e., the intersection of hemisphere HS² with the positive normal space of the surface element and the positive half-space with respect to the mirrored direction of viewing vector \vec{s}. This integration range Q in the general case has the form of a spherical triangle (trigon) which is delimited by three planes. One plane delimits the hemisphere and is perpendicular to direction vector \vec{r}. The surface element is in the second plane which is therefore perpendicular to normal vector \vec{n}. The third plane is perpendicular to mirrored direction of viewing vector \vec{s}, and the positive half-space is on the side facing the light source.

Rotationally symmetrical highlight scattering function GSF is preferably normalized to 1. This is achieved by determining GSF so that

$${\int \int }_{{1}^{->} ∈ {S}^{2}} GSF ( σ ( {1}^{->} , {s}^{->} ) ) ⅆ Ω = 1 ,$$

the integration being performed over entire sphere S² here.

Since highlight scattering function GSF is rotationally symmetrical, the following equation applies:

$${\int \int }_{{1}^{->} ∈ {S}^{2}} GSF ( σ ( {1}^{->} , {s}^{->} ) ) ⅆ Ω = 2 π \cdot {\int }_{σ = 0}^{π} GSR ( σ ) \cdot sin ( σ ) ⅆ σ .$$

GSF is thus determined so that

$$2 π \cdot {\int }_{σ = 0}^{π} GSR ( σ ) \cdot sin ( σ ) ⅆ σ = 1.$$

This formula is simplified. The simplification yields a highlight function which is a function only of angle ρ between mirrored direction of viewing vector \vec{s} and direction vector \vec{r} of the illumination, i.e., the mirrored vector in the direction of the axis of rotation of the rotationally symmetrical illumination.

In the simplification, the influence of normal vector \vec{n} on the highlights is disregarded in the integration. In the exact solution of this equation, normal vector \vec{n} does not influence the function to be integrated. In the exact solution, normal vector \vec{n} limits only integration range Ω and thus the choice of the illumination surface elements that contribute to the integration, because only surface elements that are in the positive normal space contribute to the integration. The main component of the illuminance originates from surface elements that are approximately perpendicular to mirrored direction of viewing \vec{s}, because highlight scattering function GSF preferably assumes its greatest values for small angles. If the restriction of the integration range by normal vector \vec{n} is disregarded, then integration range Ω is increased. A spherical digon Λ, namely the intersection of upper hemisphere HS² with the positive half-space of mirrored direction of viewing \vec{s}, is formed from trigon Ω. Highlight function GL is thereby simplified as follows:

$$GL ( {v}^{->} ) = {\int \int }_{{1}^{->} ∈ Λ} LVF ( ζ , ( {1}^{->} ) ) \cdot GSF ( σ ( {1}^{->} , {s}^{->} ) ) ⅆ Λ .$$

Since the mirrored direction of viewing is always in the positive normal space, only surface elements which make a smaller contribution anyway are added as a result of the enlargement of integration area Ω.

If the three vectors—normal vector \vec{n}, mirrored direction of viewing \vec{s}, and direction vector \vec{l}—are coplanar, i.e., if they are all in one plane, then integration range Ω determined by the three vectors is already in the form of a spherical digon. Additionally, if normal vector \vec{n} is situated between direction vector \vec{l} and mirrored direction of viewing \vec{s}, then simplified integration range A and correct integration range Ω coincide. Exact integration range Ω is then the intersection of upper hemisphere HS² with the positive half-space of mirrored direction of viewing \vec{s}. The simplified integral then matches the original integral.

The above integral is solved. The solution is a function only of angle ρ=ρ(\vec{r}, \vec{s}). A highlight function GF=GF(ρ)=GL(\vec{v}) is therefore generated.

Highlight function GF is preferably calculated using spherical polar coordinates (θ, φ). The polar coordinates are preferably aligned so that given direction vector \vec{r} of the direction of illumination and mirrored direction of viewing \vec{s} lie on the equator (θ=0) and given direction vector \vec{r} additionally lies on the 0-meridian (φ=0). Then

$$GF ( ρ ) = {\int }_{φ = ρ - \frac{π}{2}}^{\frac{π}{2}} {\int }_{ϑ = \frac{π}{2}}^{\frac{π}{2}} LVF [ ζ ( φ , ϑ ) ) \cdot GSF ( σ ( φ , ϑ , θ ) ) \cdot cos ( ϑ ) ⅆ ϑ ⅆ φ .$$

Light distribution function LVF and highlight scattering function GSF are preferably functions only of the cosine of angle ζ and/or σ. It then holds that LVF(ζ)N= L̅V̅F̅[cos(ζ)] and GSF(σ)= G̅S̅F̅[cos(σ)]. These two functions may be simplified as follows with the help of the formulas that are valid in the polar coordinates introduced above. It holds that: cos(ζ)=cos(θ)cos(φ) and cos(σ)=cos(θ)·cos(φ−θ). Highlight function GF is calculated according to the following formula:

$$\begin{matrix}GF ( ρ ) = {\int }_{φ = ρ - \frac{π}{2}}^{\frac{π}{2}} {\int }_{ϑ = \frac{π}{2}}^{\frac{π}{2}} \overline{LVF} [ cos ( φ ) cos ( ϑ ) ] \cdot \\ \overline{GSF} ( cos ( ϑ ) cos ( φ - ρ ) ) \cdot cos ( ϑ ) ⅆ ϑ ⅆ φ .\end{matrix}$$

This integral may be calculated at least numerically. In many cases it may even be solved explicitly, preferably using a computer algebra program. The result may also be saved in the form of a table with interpolation points or as an environment map. An environment map is known from Akenine-Möller/Haines, loc. cit., pp. 163 ff., for example.

Highlight scattering function σ→GSF(σ) is preferably bell shaped, assuming its maximum at σ=0, then declining monotonically and finally reaching 0 for angles σ>90°. The latter indicates that highlight scattering function GSF \vec{l}→GSF(σ({right arrow over (l+EE, \vec{s})) on the sphere has its carrier in the positive hemisphere around \vec{s}.

According to one embodiment, function

$$GSF ( σ ) = \frac{m + 1}{2 π} {cos}^{m} ( σ )$$

is to be used as highlight scattering function GSF for σ<90° and

$$GSF ( σ ) = 0 for σ > {90}^{°} \cdot \frac{m + 1}{2 π}$$

is used as the normalization factor; then,

$${\int \int }_{\vec{1} ∈ {HS}^{2}} {cos}^{m} ( σ ( \vec{1} ) ) ⅆ Ω = {\int }_{φ = 0}^{2 π} {\int }_{σ = 0}^{\frac{π}{2}} {cos}^{m} ( σ ) \cdot sin ( σ ) ⅆ σ ⅆ φ = \frac{2 π}{m + 1}$$

and thus

$${\int \int }_{\vec{1} ∈ {S}^{2}} GSF ( σ ( \vec{1} , \vec{s} ) ) ⅆ Ω = 1 ,$$

where HS² is the carrier of highlight scattering function GSF, namely the positive hemisphere with respect to mirrored direction of viewing \vec{s}.

A coefficient m appears in this embodiment. This coefficient is a function of the material of the surface of the object. The “harder” this material, the greater is the concentration of the highlight generated in the direction of ideal reflection and the greater is the concentration of highlight scattering function GSF=GSF[m].

For m→∞ othe highlight becomes the ideally reflected light from the sky, i.e.:

$$m {\to }^{lim} ∞ GF [ m ] ( ρ ) = LVF ( ρ ) .$$

When using the polar coordinates introduced above, this highlight scattering function GSF yields highlight function GF as follows:
from

$$GF ( ρ ) = {\int }_{φ = ρ - \frac{π}{2}}^{\frac{π}{2}} {\int }_{ϑ = - \frac{π}{2}}^{\frac{π}{2}} \overline{LVF} [ cos ( φ ) \cdot cos ( ϑ ) ] \cdot \overline{GSF} ( cos ( ϑ ) cos ( φ - ρ ) ) \cdot cos ( ϑ ) ⅆ ϑ ⅆ φ ,$$

this yields

$$GF ( ρ ) = \frac{m + 1}{2 π} {\int }_{φ = ρ - \frac{π}{2}}^{\frac{π}{2}} {\int }_{ϑ = - \frac{π}{2}}^{\frac{π}{2}} \overline{LVF} ( cos ( φ ) \cdot cos ( ϑ ) ) \cdot {cos ( ϑ )}^{m + 1} \cdot {cos ( φ - ρ )}^{m} ⅆ ϑ ⅆ φ .$$

In this formula, angle ρ is given in arc degrees. In the following formulas, the angle is given in radians. It is known that an angle may be converted from degrees to radians by multiplying it by π/180.

Some embodiments of diffuse light sources and the embodiment of the method for these light sources are described below. Each light source is preferably described by three functions, namely by light distribution function ζ→LVF(ζ), brightness function θ→HF(θ) and highlight function ρ→GF(ρ). These three functions are preferably scaled using the same scaling factor, so that one of the three functions is normalized to the range of 0 to 1. In one embodiment, this scaling factor is selected so that HF(0)=1. The two other functions are then no longer scaled to the interval from 0 to 1.

Angle θ is always given below in degrees between 0° and 180°. The isotropic sky according to CIE type 5 (“sky of uniform luminance”) has light distribution function LVF with

$$LVF ( ζ ) = \frac{1}{π} for ζ < {90}^{°} and LVF ( ζ ) for ζ \geq {90}^{°} .$$

The embodiment just described yields brightness function HF mentioned above with

$$HF ( θ ) = \frac{cos ( θ ) + 1}{2} .$$

Resulting highlight function GF is a function of a parameter m and is in the form

$$GF ( ρ ) = GF [ m ] ( ρ ) = \frac{m + 1}{2 {π}^{2}} \cdot ICOSN ( m + 1 , 0 ) \cdot ICOSN ( m , ρ ) .$$

This parameter m is a function of the material of the surface of the object, as described above. ICOSN is a function of angle ρ and number [sic; parameter ] m and is calculated according to the formula

$$ICOSN ( m , ρ ) = {\int }_{ϑ = - \frac{π}{2}}^{\frac{π}{2} - ρ} {cos ( ϑ )}^{m} ⅆ ϑ .$$

Although it is possible to calculate this interval exactly with the help of an analytical formula, ICOSN(m, ρ) is, however, preferably calculated recursively using the following formula, which is valid for n=1, 2, . . . , m:

$$ICOSN ( 0 , ρ ) - π - ρ , \\ ICOSN ( 1 , ρ ) = cos ( ρ ) + 1 , \\ ICOSN ( n , ρ ) = \frac{1}{n} \cdot {sin ( ρ )}^{n - 1} \cdot cos ( ρ ) + \frac{n - 1}{n} \cdot ICOSN ( n - 2 , ρ ) .$$

FIG. 4 shows light distribution function LVF, brightness function HF, and some highlight functions GF=GF[m] for the isotropic sky. Arguments between 0° and 180° are plotted on the x axis in FIG. 4. Light distribution function LVF of the isotropic sky is represented by curve 119 in FIG. 4, and brightness function HF is represented by curve 110. In addition, the curves of some highlight functions GF[m] for different parameters m are shown, namely for m=1 (curve 111), m=2 (curve 112), m=8 (curve 113), and m=64 (curve 114).

The “cosine sky,” as it is called, has a light distribution function

$$\begin{matrix}LVF of LVF ( ζ ) = \frac{3}{2 π} cos ( ζ ) < {90}^{°} and LVF ( ζ ) \\ = 0 for ζ \geq {90}^{°} .\end{matrix}$$

In the case of the cosine sky, the approach described above yields brightness function HF with

$$HF ( θ ) = cos ( θ ) - \frac{θ}{180} \cdot cos ( θ ) + \frac{1}{π} \cdot sin ( θ )$$

$$and highlight function GF with$$

$$GF ( ρ ) = \frac{3 ( m + 1 )}{4 {π}^{2}} \cdot ICOSN ( m + 2 , 0 ) \cdot ( cos ( ρ ) \cdot ICOSN ( m + 1 , ρ ) \cdot \frac{1}{m + 1} \cdot {sin ( ρ )}^{m + 2} ) .$$

FIG. 5 shows light distribution function LVF, brightness function HF, and some highlight functions GF=GF[m] for the cosine sky. Light distribution function LVF of the cosine sky is represented by curve 129 in FIG. 5, and brightness function HF is represented by curve 120 in FIG. 5. In addition, the curves of some highlight functions GF[m] for different parameters m are also shown, namely for m=1 (curve 121), m=2 (curve 122), m=8 (curve 123), and m=64 (curve 124).

The “traditional overcast sky,” which was introduced by Moon/Spencer, loc. cit., has light distribution functions

$$\begin{matrix}LVF ( ζ ) = \frac{3}{7 π} \cdot ( 1 + 2 \cdot cos ( ζ ) ) for ζ < {90}^{°} and LVF ( ζ ) \\ = 0 for ζ \geq {90}^{°} .\end{matrix}$$

In the case of the traditional overcast sky, the approach described above yields brightness function HF with

$$HF ( θ ) = \frac{3}{14} + \frac{4}{7 π} \cdot sin θ + \frac{1}{14} \cdot ( 11 - \frac{2}{45} \cdot θ ) \cdot cos θ .$$

The highlight function of the traditional overcast sky is

$$GF ( ρ ) = \frac{3 \cdot ( m + 1 )}{14 {π}^{2}} \cdot [ \frac{ICOSN ( m + 1 , 0 ) \cdot ICOSN ( m , ρ )}{\begin{matrix}+ 2 \cdot ICOSN ( m + 2 , 0 ) \cdot \\ ( cos ( ρ ) \cdot ICOSN ( m + 1 , ρ ) + \frac{1}{m + 1} \cdot {sin ( ρ )}^{m + 2} )\end{matrix}} ]$$

FIG. 6 shows light distribution function LVF, brightness function HF, and some highlight functions GF=GF[m] for the traditional overcast sky. Light distribution function LVF of the traditional overcast sky is represented by curve 139 in FIG. 6; brightness function HF is represented by curve 130. In addition, the curves of some highlight functions GF[m] for various parameters m are shown, namely for m=1 (curve 131), m=2 (curve 132), m=8 (curve 133), and m=64 (curve 134).

Function ICOSN, which is a function of angle ρ and parameter m, occurs in all these highlight functions. FIG. 7 shows graphs of the ICOSN function for four values for m as a function of angle ρ. Angle ρis plotted on the x axis. Graphs for m=1 (curve 151), m=2 (curve 152) and m=8 (curve 153), m=64 (curve 154) are shown here.

FIG. 8 shows brightness function HF and some highlight functions GF of the punctiform source as examples. The light distribution function of conventional directional light is Dirac's delta distribution with LVF(0)=∞ and otherwise always LVF(ζ)=0 and is not displayable. Brightness function HF has the form HF(θ)=max {cos(θ), 0}.

Highlight function GF=GF[m] also depends on parameter m and is given by

$$GF [ m ] ( ρ ) = \frac{m + 1}{2 π} {cos}^{m} ( ρ ) for ρ \leq {90}^{°} and GF [ m ] ( ρ ) = 0 for ρ > {90}^{°} .$$

In FIG. 8, brightness function pHF of the illumination through the punctiform light source is represented by curve 140. Highlight functions pGF[m] for m=1 (curve 141), m=2 (curve 142), m=8 (curve 143), m=64 (curve 144) are also shown with curve 144 being chopped off.

Preferably at least one highlight function GF, which is calculated as described above, for example, is additionally predefined for the method. This function GF has angles from 0° to 180° as the set of arguments. It is possible to specify a first highlight function GF1 for the highlights due to the first illumination and a second highlight function GF1 [sic; GF2] for the highlights due to the second illumination.

In addition, the given direction of viewing \vec{v} is mirrored about normal \vec{n} of pixel BP for each selected pixel BP. The mirroring simulates the physical law of reflection of an ideally mirroring surface. Normals \vec{n}, direction of viewing \vec{v}, and mirrored direction of viewing \vec{s} are all in one plane. A mirrored direction of viewing \vec{s} is generated by mirroring.

FIG. 9 illustrates how direction of viewing vector \vec{v} is mirrored and how angle ρ between a vector in the direction of mirrored direction of viewing \vec{s} and a direction vector \vec{r1} of the first illumination are calculated. FE is a surface element. Angle α between normal \vec{n} and direction of viewing \vec{v} is equal to angle β between normal \vec{n} and mirrored direction of viewing \vec{s}.

Mirrored direction of viewing \vec{s} is preferably calculated by the formula
\vec{s}=2·cos(β)·\vec{n}−\vec{v}
where cos(β) is the cosine of angle β between the two vectors \vec{n} and \vec{v}.

Both normal vector \vec{n} and direction of viewing vector \vec{v} preferably have a length of 1, i.e., ∥\vec{n}∥=∥\vec{v}∥=∥\vec{s}∥=1. The formula is then simplified to \vec{s}=2·<\vec{n}, \vec{v}>·\vec{n}−\vec{v}, where <\vec{n}, \vec{v}> is the scalar product of these two vectors. The following then applies: <\vec{n}, \vec{v}>=cos(β)·∥\vec{n}∥·∥\vec{v}∥.

Angle ρ1 between mirrored direction of viewing \vec{s} and first direction of illumination \vec{r1} is calculated. A first highlight value GW1 of pixel BP is calculated as a function value GF(ρ1) of the given at least one highlight function GF. First highlight value GW1 is greatest when mirrored direction of viewing \vec{s} is parallel to a direction of the strongest illuminance of the first illumination. In many cases, the direction of the strongest illuminance is equal to the given first direction of illumination \vec{r1}.

Similarly, angle ρ2 between mirrored direction of viewing \vec{s} and second direction of illumination \vec{r2} is calculated. By using the formula GW2=GF(ρ2), a second highlight value GW2 of pixel BP is calculated.

In one embodiment, two highlight functions are predefined, namely a first highlight function GF1 of the first diffuse light source and a second highlight function GF2 of the punctiform or directional light source. First highlight function GF1 preferably assigns the function value 0 to the argument 180° and assigns one function value greater than 0 to each argument less than 180°. All angles smaller than 180° thus have a function value greater than 0. The set of images of first highlight function GF1, i.e., the set of function values, is thus the set of real numbers greater than or equal to 0.

In one embodiment, the first light source is the “isotropic sky” introduced above, and first brightness function HF1 has the form represented by curve 12 in FIG. 2:

$$HF 1 \_iso ( θ ) = \frac{cos ( θ ) + 1}{2} .$$

A function which depends on a parameter m and has the following form is preferably predefined as first highlight function GF1:

$$GF ( ρ ) = GF [ m ] ( ρ ) = \frac{m + 1}{2 {π}^{2}} \cdot ICOSN ( m + 1 , 0 ) \cdot ICOSN ( m , ρ ) .$$

This parameter m is a function of the material of the surface of the object. ICOSN is a function of angle ρ and parameter m and is calculated according to the formula

$$ICOSN ( m , ρ ) = {\int }_{ϑ = - \frac{π}{2}}^{\frac{π}{2} - ρ} {cos ( ϑ )}^{m} ⅆ ϑ .$$

As described above, this integral is preferably calculated recursively.

In one embodiment, the first light source is the “traditional overcast sky” introduced above. The following is then predefined as highlight function GF1:

$$GF 1 ( ρ ) = \frac{3 \cdot ( m + 1 )}{14 {π}^{2}} \cdot [ \frac{ICOSN ( m + 1 , 0 ) \cdot ICOSN ( m , ρ )}{+ 2 \cdot ICOSN ( m + 2 , 0 ) \cdot ( \begin{matrix}cos ( ρ ) \cdot ICOSN ( m + 1 , ρ ) + \\ \frac{1}{m + 1} \cdot {sin ( ρ )}^{m + 2}\end{matrix} )} ]$$

The second light source is, for example, a punctiform light source or a directional light source for which a second brightness function HF2 is predefined, with HF2(θ)=max[cos(θ), 0]. For example, function GF2 is predefined as highlight function GF2 with the following:

$$GF 2 ( ρ ) = \frac{3 ( m + 1 )}{4 {π}^{2}} \cdot ICOSN ( m + 2 , 0 ) \cdot ( \begin{matrix}cos ( ρ ) \cdot ICOSN \\ ( m + 1 , ρ ) + \\ \frac{1}{m + 1} \cdot {sin ( ρ )}^{m + 2}\end{matrix} ) .$$

A first brightness value HW1_BP and a second brightness value HW2_BP are calculated for each selected pixel BP. First brightness value HW1_BP describes the effect of the first illumination on the object in pixel BP; second brightness value HW2_BP describes the effect of the second illumination.

As described above, pixels of the surface elements are selected. For each of these pixels, a basic color hue FT_BP is predefined. This basic color hue FT_BP describes the matteness or diffuse reflection, i.e., a color hue that does not depend on the direction of viewing. For example, such a basic color hue is specific for each surface element of the breakdown described above and each pixel of the surface element accordingly receives a basic color hue. It is also possible to specify a basic color hue for each corner of a surface element and to calculate the basic color hue of a pixel in the interior by interpolation via the basic color hues of the corners. The interpolation depends on the position of the pixel in the surface element.

These basic hues of the pixels are processable independently of the quantity of input signals processable by video display unit 2 and may be defined and varied independently of the illumination and its color hues and light intensities.

The basic color hue of each pixel BP is preferably predefined in the form of an RGB vector. Each basic color hue FT_BP in the form of an RGB vector then has three values, namely a red value FT_BP_r, a green value FT_BP_g, and a blue value FT_BP_b. The red value indicates the percentage amount of incident red light reflected. Accordingly, the green value and the blue value indicate the amounts of green and blue light reflected, respectively. The ratio of the values to one another determines the basic color hue. The basic color hue indicates in what color and brightness white light is reflected.

First brightness value HW1_BP of pixel BP is preferably an RGB vector having red value HW1_BP_r, green value HW1_BP_g, and blue value HW1_BP-b.

In a first embodiment, first brightness value HW1_BP is a function only of angle θ1 between normal vector \vec{n} at the pixel and first direction of illumination \vec{r1} as well as basic color hue FT_BP. It is equal to a first illumination value BL1_BP having red value BL1_BP_r, green value BL1_BP_g, and blue value BL1_BP_b. First illumination value BL_BP is calculated in step S21 of FIG. 12 according to the following formulas
BL1_{—}BP_{—}r=HF1(θ1)·FT_{—}BP_{—}r
BL1_{—}BP_{—}g=HF1(θ1)·FT_{—}BP_{—}g
BL1_{—}BP_{—}b=HF1(θ1)·FT_{—}BP_{—}b.

Function value HF1(θ1) is preferably calculated once and stored temporarily. Similarly, the second brightness value is calculated according to the formulas
BL2_{—}BP_{—}r=HF2(θ1)·FT_{—}BP_{—}r
BL2_{—}BP_{—}g=HF2(θ1)·FT_{—}BP_{—}g
BL2_{—}BP_{—}b=HF2(θ1)·FT_{—}BP_{—}b.

In the first embodiment, HW1_BP=BL1_BP and HW2_BP=BL2_BP and thus no highlights are taken into account.

In a second embodiment, both brightness values HW1_BP and HW2_BP of a pixel BP are additionally functions of the particular highlight. Both brightness values HW1_BP and HW2_BP thus are additionally functions of given direction of viewing \vec{v}. For each selected pixel BP, in addition to basic color hue FT_BP, a highlight color hue GFT_BP of each pixel BP is also predefined. Highlight color hue GFT_BP is preferably also predefined in the form of an RGB vector having red value GFT_BP_r, green value GFT_BP_g, and blue value GFT_BP_b.

With the help of first highlight function GF1, a first highlight value GW1_BP is then calculated. This is preferably an RGB vector having red value GW1_BP_r, green value GW1_BP_g, and blue value GW1_BP_b. First highlight value GW1_BP is preferably calculated in step S22 of FIG. 12 according to the formulas:
GW1_{—}BP_{—}r=GFT_{—}BP_{—}r·GF1(Σ1)
GW1_{—}BP_{—}g=GFT_{—}BP_{—}g·GF1(ρ1)
GW1_{—}BP_{—}b=GFT_{—}BP_{—}b·GF1(ρ1)
where ρ1 is the angle between mirrored direction of viewing \vec{s} and first direction of illumination \vec{r1}. Accordingly, a second highlight value GW2_BP is calculated according to the formulas:
GW2_{—}BP_{—}r=GFT_{—}BP_{—}r·GF2(ρ2)
GW2_{—}BP_{—}g=GFT_{—}BP_{—}g·GF2(ρ2)
GW2_{—}BP_{—}b=GFT_{—}BP_b·GF2(ρ2).

First brightness value HW1_BP of pixel BP is calculated in the second embodiment in step S16, preferably according to the formulas
HW1_{—}BP_{—}r=BL1_{—}BP_{—}r+GW1_{—}BP_{—}r
HW1_{—}BP_{—}g=BL1_{—}BP_{—}g+GW1_{—}BP_{—}g
HW1_{—}BP_{—}b=BL1_{—}BP_{—}b+GW1_{—}BP_{—}b
and second brightness value HW2_BP is calculated according to the formulas
HW2_{—}BP_{—}r=BL2_{—}BP_{—}r+GW2_{—}BP_{—}r
HW2_{—}BP_{—}g=BL2_{—}BP_{—}g+GW2_{—}BP_{—}g
HW2_{—}BP_{—}b=BL2_{—}BP_{—}b+GW2_{—}BP_{—}b,
where BL1_BP and BL2_BP are the first and second illumination values of pixel BP, respectively, as described above.

Other formulas for combining first illumination value BL1_BP and first highlight value GW1_BP are possible, e.g., HW1_BP=BL1_BP·[1+GW1_BP]. Another formula uses a compensating factor γ_comp, which is explained in greater detail below. The first brightness value is calculated according to the formula HW1_BP=[BL1_BP^{1/γ}^{_{—}}^{comp}+GW1_BP^{1/γ}^{_{—}}^{comp}]^{γ}^{_{—}}^{comp}.

Other formulas are also possible for combining second illumination value BL2_BP and second highlight value GW2_BP.

A light intensity of the light source of the first illumination and a light intensity of the light source of the second illumination are predefined. These light intensities indicate how intense the particular illumination is on the surface of the illuminated object. A first light intensity of the pixel resulting from the first illumination for each pixel of a surface element selected is calculated as is a second light intensity of the pixel resulting from the second illumination.

In one embodiment, the light intensity of the first illumination on the surface of the object and the light intensity of the second illumination on the surface of the object are predefined directly.

In contrast, another embodiment specifies the light intensity of the first illumination and the light intensity of the second illumination at a predefined reference distance dist_ref from the particular light source, e.g., at a minimum distance. In addition, distance dist(LQ_1, G) between the first light source and the object as well as distance dist(LQ_2, G) between the second light source and the object are predefined. The predefined light intensity of the first light source is multiplied by the factor

$${[ \frac{dist\_ref}{dist ( LQ\_ 1 , BP )} ]}^{2} ,$$

while the predefined light intensity of the second light source is multiplied by the factor

$${[ \frac{dist\_ref}{dist ( LQ\_ 2 , BP )} ]}^{2} .$$

This embodiment takes into account the physical fact that the light intensity of a localizable light source, in particular a punctiform light source, decreases with the square of the distance from the illuminated object.

FIG. 13 illustrates the calculation of the distance between a light source and the illuminated object in one embodiment. This embodiment is used when the light source is approximately a punctiform source. In this case, a Cartesian coordinate system is preferably predefined. The given surface model 8 is positioned in this coordinate system. A point P of this coordinate system belonging to surface model 8 is defined, e.g., origin O of the coordinate system. Distance dist(LQ, G) between the light source and the object is predefined in this second embodiment by specifying distance dist(LQ, P) between the light source and defined point P.

The position of a point P_LQ of light source LQ in this coordinate system is either predefined directly or determined. Determination of P_LQ is preferably performed by the following method: a vector having the following properties is calculated:

It has the direction of given direction of illumination \vec{r}. This direction of illumination \vec{r} points away from surface model 8 in the direction of the light source.

It begins at defined point P.

It has length dist(LQ, P).

The end point of this vector specifies the position of point P_LQ of the light source. Therefore the vector in FIG. 13 is referred to as P_\vec{L} Q. Distance dist(LQ, BP) is calculated as the distance between points P_LQ and BP. This distance is calculated as the length of the difference vector between the position vector of P_LQ and the position vector of BP, i.e., according to the formula dist(BP, P)=∥P_\vec{L} Q−\vec{B} P∥.

FIG. 14 illustrates a third embodiment for calculating the distance between pixel BP and the light source. This embodiment is used when the light source is spatially extensive and the spatial extent of the object is not negligible.

The distance between the light source and the object is in turn based on predefined point P. A straight line g describing the direction of the spatial extent of the light source is calculated. This straight line g is determined so that it has predefined distance dist(LQ, P) from predefined point P and is perpendicular to the direction of illumination \vec{r}. Point P_LQ, which is the smallest distance from pixel BP, is determined on this line g. The segment from P_LQ to BP is perpendicular to line g. Again the distance between P_LQ and BP is used in the given coordinate system as distance dist(LQ, BP) which is being sought.

Technical illumination parameters luminous flux Φ light intensity I, and illuminance E are presented in “Dubbel-Taschenbuch für den Maschinenbau” [Dubbel's Handbook for Mechanical Engineering] 20^{th} edition, Springer-Verlag, 2001, W18-W20 and Z7. Luminous flux Φ is given in lumens. Light intensity I is measured in candela=lumen per steradiant and illuminance is measured in lux=lumen per m². Light intensity is referred to in Poynton, p. 605 as “luminous intensity” and “illumination intensity” is referred to as “illuminance.” In addition, luminescence L (“luminance”) is introduced as luminous intensity I per m² and is measured in candelas per m².

The first and second light intensity and the total light intensity of a pixel are calculable as light technical parameters, e.g., in the form of the light intensity, illuminance, or luminescence.

In this exemplary embodiment, the two predefined light intensities including the color hues of the two illuminations are described by two color hue light intensities LI_LQ_1 and LI_LQ_2. The two resulting light intensities and color hues of each pixel are calculated in the form of resulting color hue light intensities LI_BP_1 and LI_BP_2, namely a first light value LI_BP_1 resulting from the first illumination and a second light value LI_BP_2 resulting from the second illumination.

All the predefined and calculated color hue light intensities have preferably the form of RGB vectors, each having one red value, one green value, and one blue value. The ratio of a red value, green value, and blue value determines the color hue, while the absolute values of the red value, the green value, and the blue value determine the light intensity of the light source and/or the pixel. The greater the red value, green value, and blue value, the lighter is the illumination and/or the lighter the appearance of the pixel. Basic color hue FT_BP of each pixel BP is described by an RGB vector.

Predefined color hue light intensity LI_LQ_l of the first illumination is made up of the RGB vector having red value LI_LQ_1_r, green value LI_LQ_1_g, and blue value LI_LQ_1_b. For example, color hue light intensity LI_LQ_1_ref of the first illumination is predefined in the form of an RGB vector from reference distance dist_ref described above. In addition, distance dist(LQ_1, G) between the first light source and the object to be displayed is also predefined. The RGB vector for LI_LQ_1 describes the color hue light intensity of the first illumination on the surface of the object to be displayed and is calculated in step S15 according to the following formulas

$$LI\_LQ \_ 1 \_r = LI\_LQ \_ 1 \_ref \_r \cdot {[ \frac{dist\_ref}{dist ( LQ\_ 1 , G )} ]}^{2}$$

$$LI\_LQ \_ 1 \_g = LI\_LQ \_ 1 \_ref \_g \cdot {[ \frac{dist\_ref}{dist ( LQ\_ 1 , G )} ]}^{2}$$

$$LI\_LQ \_ 1 \_b = LI\_LQ \_ 1 \_ref \_b \cdot {[ \frac{dist\_ref}{dist ( LQ\_ 1 , G )} ]}^{2} .$$

The procedure is similar for color hue light intensity LI_LQ_2 of the second illumination. These calculations naturally need be performed only once per distance.

Calculated first color hue light intensity LI_BP_1 of a selected pixel BP is made up of the RGB vector having red value LI_BP_1_r, green value LI_BP_1_g, and blue value LI_BP_1_b. Basic color hue FT_BP of each pixel BP is made of the RGB vector having red value FT_BP_r, green value FT_BP_g, and blue value FT_BP_b. Color hue light intensity LI_LQ_2 of the second illumination and second calculated color hue light intensity LI_BP_2 are each preferably made up of an RGB vector having one red value, one green value, and one blue value.

In one embodiment, the red value, the green value, and the blue value of each RGB vector are each expressed by a number between 0 and 1. In another embodiment, the red value, the green value, and the blue value are each expressed by an integer between 0 and 255, i.e., an 8-bit code of the form

$${\sum }_{i = 0}^{7} {a}_{i} \cdot {2}^{i}$$

where aᵢ=0 or aᵢ=1 for i=0, 1, . . . , 7. In another embodiment, the red value, the green value, and the blue value are each 16-bit codes or 32-bit codes and thus are in the form

$${\sum }_{i = 0}^{15} {a}_{i} \cdot {2}^{i}$$

$$or$$

$${\sum }_{i = 0}^{31} {a}_{i} \cdot {2}^{i}$$

with aᵢ=0 or aᵢ=1.

In the case of an 8-bit code, the number

$${\sum }_{i = 0}^{7} {a}_{i} \cdot {2}^{i}$$

is between 0 and 2⁸−1=255 (inclusive). Quotient

$${\sum }_{i = 0}^{7} {a}_{i} \cdot {2}^{i} / ( {2}^{8} - 1 )$$

is equal to the reflected light portion.

First, the two resulting color hue light intensities LI_BP_1 and LI_BP_2 of a pixel BP are calculated separately. Red value LI_BP_1_r, green value LI_BP_1_g, and blue value LI_BP_1_b of color hue light intensities LI_BP_1 resulting from the first illumination are preferably calculated according to the following formulas:
LI_{—}BP_{—}1_{—}r=HW1_{—}BP_{—}r·LI_{—}LQ_{—}1_{—}r
LI_{—}BP_{—}1_{—}g=HW1_{—}BP_{—}g·LI_{—}LQ_{—}1_{—}g
LI_{—}BP_{—}1_{—}b=HW1_{—}BP_{—}b·LI_{—}LQ_{—}1_{—}b.

In one embodiment described above of the combination of illumination values and brightness values, this results in the formulas
LI_{—}BP_{—}1_{—}r=(BL1_{—}BP_{—}r+GW1_{—}BP_{—}r)·LI_{—}LQ_{—}1_{—}r
LI_BP_{—}1_{—}g=(BL1_{—}BP_{—}g+GW1_{—}BP_{—}g)·LI_LQ_{—}1_{—}g
LI_{—}BP_{—}1_{—}b=(BL1_{—}BP_{—}b+GW1_{—}BP_{—}b)·LI_{—}LQ_{—}1_{—}b.

Similarly, red value LI_BP_2_r, green value LI_BP_2_g, and blue valued LI_BP_2_b of color hue light intensities LI_BP_2 resulting from the second illumination are calculated using the following formulas:
LI_{—}BP_{—}2_{—}r=HW2_{—}BP_{—}r·LI_{—}LQ_{—}2_{—}r=(BL2_{—}BP_{—}r+GW2_{—}BP_{—}r)·L2_{—}LQ_{—}1_{—}r
[sic; LI_LQ_2_r]
LI_{—}BP_{—}2_{—}g=HW2_{—}BP_{—}g·LI_{—}LQ_{—}2_{—}g=(BL2_{—}BP_{—}g+GW2_{—}BP_{—}g)·LI_{—}LQ_{—}2_{—}g
LI_{—}BP_{—}2_{—}b=HW2_{—}BP_{—}b·LI_{—}LQ_{—}2_{—}b=(BL2_{—}BP_{—}b+GW2_{—}BP_{—}b)·LI_{—}LQ_{—}2_{—}b

HW1_BP and HW2_BP are the two brightness values of the pixel whose calculation was described above. They are preferably in the form of two RGB vectors.

Two resulting color hue light intensities LI_BP_1 and LI_BP_2 of the pixel are then combined to form a total color hue light intensity LI_BP_tot. Total color hue light intensity LI_BP_tot of the pixel is made up of an RGB vector having a red value BP_r_{—}tot, a green value BP_g_tot, and a blue value BP_b_tot.

The combination is preferably performed by adding two resulting color hue light intensities LI_BP_1 and LI_BP_2 as components. Then
LI_{—}BP_tot_{—}r=LI_{—}BP_{—}1_{—}r+LI_{—}B_{—}2_{—}r
LI_{—}BP_tot_{—}g=LI_{—}BP_{—}1_{—}g+LI_{—}B_{—}2_{—}g
LI_{—}BP_tot_{—}b=LI_{—}BP_{—}1_{—}b+LI_{—}B_{—}2_{—}b.

This total color hue light intensity LI_BP_tot has a physical meaning. For example, the calculated total color hue light intensity defines a light intensity, an illuminance or a luminescence of the light intensity reflected by the illuminated object at the pixel. In addition, it indicates the color hue of this light intensity, illuminance or luminescence.

A computer-accessible display 9 of the illuminated object is generated. This display 9 is generated with the help of surface model 8 in the exemplary embodiment. It includes the selected pixels and their positions and calculated total color hue light intensities.

Each total color hue light intensity LI_BP_tot of a pixel BP is transformed into an input signal processable by video display unit 2 for the pixel. Many video display units are capable of processing only RGB vectors made of up three 8-bit values. These three values are the three codes for the red value, the green value, and the blue value. In this case, each input signal is thus an RGB vector and is made up of three integers, each being between 0 and 255. However, this method may also be applied to any other form of processable input signals.

The transformation is preferably performed as follows: let LI_BP_tot_r, LI_BP_tot_g, and LI_BP_tot_b be the red value, the green value, and the blue value, respectively, of total color hue light intensity LI_BP_tot of the selected pixel. An RGB vector having red value LI_BG_max_r, green value LI_BG_max_g, and blue value LI_BG_max_b of a pure white having the maximum light intensity displayable by video display unit 2 is predefined. For example, LI_BG_max_r=LI_BG_max_g=LI_BG_max_{—r}=255. Processable input signal ES_BP for each pixel includes an RGB vector having red value ES_BP_r, green value ES_BP_g, and blue value ES_BP_b. In this embodiment, the transformation is calculated according to the formulas:

$$ES\_BP \_r = floor ( \frac{LI\_BP \_tot \_r}{LI\_BG \_max \_r} \cdot 255 )$$

$$ES\_BP \_g = floor ( \frac{LI\_BP \_tot \_g}{LI\_BG \_max \_b} \cdot 255 )$$

$$ES\_BP \_b = floor ( \frac{LI\_BP \_tot \_b}{LI\_BG \_max \_b} \cdot 255 )$$

where floor(x) denotes the largest integer less than or equal to x.

The gamma behavior of a cathode ray tube (CRT) is known from Ch. Poynton: “Digital Video and HDTV”, Morgan Kaufmann, San Francisco, 2003, pp. 271 ff. Light intensity L with which video display unit 2 displays a pixel BP is not proportional to the analog value of input signal ES_BP which is sent to video display unit 2 and which specifies the coded setpoint light intensity. The gamma behavior, i.e., the relationship between input signal ES for the setpoint light intensity and actual display light display L which with video display unit 2 displays the pixel is described by gamma transfer function Γ. Gamma transfer function Γ for the gamma behavior of a video display unit is described by Ch. Poynton, loc. cit., p. 272 as being function L=ES^{γ}. Factor γ of video display unit 2 is known as the gamma factor. Gamma factor γ depends on video display unit 2 and is usually between 2.2 and 2.9. Other descriptions of gamma behavior are also to be found in Ch. Poynton, loc. cit.

For the compensation, it is assumed that the gamma behavior of video display unit 2 is described by LI_BP_BG=Γ(ES-BP), e.g., by ES_BP^{γ}^{_{—}}^{BG}, where LI_BP_BG denotes the light intensity with which video display unit 2 displays a pixel BP for which input signal ES_BP is transmitted to video display unit 2. The gamma behavior is taken into account by inverting gamma transfer function Γ, which supplies a compensation function Γ⁻¹. Compensating total color hue light intensity LI_BP_tot_comp of pixel BP is taken into account by a compensation factor γ_comp according to the formula LI_BP_tot_comp=Γ⁻¹(LI_BP_tot). In one embodiment γ_comp=1/γ_BG and LI_BP_tot_comp=LI_BP_tot^{γ}^{_{—}}^{comp}=LI_BP_tot^{(1/γ}^{_{—}}^{BG)}.

The ambient illumination is preferably additionally taken into account through a viewing gamma factor γ_view. Viewing gamma factor γ_view is a function of the ambient illumination in which video display unit 2 is situated. It is usually between 1 and 1.5. For a dark environment such as a movie theater γ_view=1.5 is preferably selected; for a bright environment, γ_view=1 and for a PC in an office environment γ_view=1.125. To take into account ambient lighting, compensation factor γ_comp is calculated according to formula γ_comp=γ_view/γ_BG. Preferred values for γ_comp are thus between 1/2.2 and 1/1.45. If video display unit 2 is a camera, then preferably γ_comp=1/1.95. Again LI_BP_tot_comp=LI_BP_tot^{γ}^{_{—}}^{comp}.

In a first embodiment of gamma compensation, total color hue light intensity LI_BP_tot of each pixel BP is first transformed into an input signal processable by video display unit 2 without having to take into account here the gamma behavior of video display unit 2. An input signal compensating for the gamma behavior is then calculated from the input signal. If each processable input signal is an 8-bit RGB vector, then, for the second computation step, another 8-bit RGB vector is calculated from each 8-bit RGB vector.

In a second embodiment of gamma compensation, these two steps are performed in the opposite order. First a total color hue light intensity LI_BP_tot_comp that compensates for the gamma behavior of video display unit 2 is calculated from total color hue light intensity LI_BP_tot of each pixel. In this first step, this does not take into account which input signals video display unit 2 is capable of processing. The compensating total color hue light intensity is then transformed into a processable and compensating input signal.

A continuation of the second embodiment is used when a preview has been calculated first, showing the object illuminated only by the first light source and then a display is calculated showing the object illuminated by two light sources. The choice of pixels remains unchanged. To calculate the preview display, a gamma behavior-compensating first color hue light intensity LI_BP_1_comp was calculated for each pixel. This is done by calculating first color hue light intensity LI_BP_1 as described above and then calculating the first compensating color hue light intensity according to the formula LI_BP_I_comp=Γ⁻¹(LI_BP_1) with the help of inverted gamma transfer function Γ⁻¹. Computation results are then preferably used again.

In particular, compensating first color hue light intensity LI_BP_1_comp of each pixel BP is used again. To calculate the display showing the object illuminated by the two light sources, a second color hue light intensity LI_BP_2 of pixel BP is calculated as described above. A second compensating color hue light intensity LI_BP_2_comp is calculated from this according to formula LI_BP_2_comp=γ⁻¹(LI_BP_2). Compensating total color hue light intensity LI_BP_tot_comp is then calculated by combining two compensating color hue light intensities LI_BP_1_comp and LI_BP_2_comp. This is preferably done according to the formula LI_BP_tot_comp=Γ⁻¹[γ(LI_BP_1_comp)+Γ(LI_BP_2_comp)].

If the two color hue light intensities are RGB vectors, the calculations are performed component by component, i.e., separately for the red value, the green value, and the blue value.

A similar embodiment is preferably also performed when the highlights produced by the first illumination are taken into account subsequently. First a preview display, which does not take into account the highlights due to the first illumination, is generated. As described above, a first illumination value BL1_BP of each pixel BP is calculated, without taking into account highlights, and used as first brightness value HW1_BP in the preview display. A first color hue light intensity LI_BP_1 of pixel BP is calculated from first brightness value HW1_BP. A compensating first color hue light intensity LI_BP_1_comp is calculated from this first color hue light intensity LI_BP_1.

This “old” first compensating first color hue light intensity LI_BP_1_comp_old is now used again. As described above, a first highlight value GW1_BP is calculated. A color hue light intensity LI_LQ)_1 of the first illumination is predefined. The “new” first compensating first color hue light intensity LI_BP_l comp_new is [calculated] according to the formula LI_BP_1_comp_new=γ⁻¹[γ(LI_BP_1_comp_old)+GW1_BP_LI_LQ_1].

A display 9 of the illuminated object is generated. This display 9 includes selected pixels of surface model 8. Their positions in a predefined coordinate system are predefined by surface model 8. In addition, a processable input signal for the pixel, which is generated as described above, belongs to generated display 9 per selected pixel.

Display 9 including the positions and the processable input signals of the selected pixels is transmitted to video display unit 2. Video display unit 2 displays display 9 using these positions and input signals.

FIG. 10 shows a flow chart illustrating how display 9 is generated. It shows the following steps:

The surface of surface model 8 is broken down network-like in step S1. Surface elements are formed as result E1.

Using result E1 and given direction of viewing \vec{v}, the following steps are performed for each surface element FE:

In step S2 a normal \vec{n} to FE is calculated.

In step S3 the surface elements visible from direction of viewing \vec{v} are determined. The visible surface elements form result E2.

In step S4 points of these visible surface elements are selected as pixels of display 9 to be generated. The selected pixels form result E3.

The following steps are then performed for each selected pixel BP:

A normal vector \vec{n} or selected pixel BP is calculated, using the normal vectors of the surface elements.

In step S5 color hue light intensity LI_BP_1 of pixel BP resulting from the first illumination is calculated. The calculation is shown in detail in FIG. 11.

In step S6 color hue light intensity LI_BP_2 of pixel BP resulting from the second illumination is calculated. This calculation is performed like the calculation illustrated in FIG. 6. Steps S5 and S6 may be performed sequentially or simultaneously.

In step S7 first color hue light intensity LI_BP_1 and second color hue intensity LI_BP_2 are aggregated to yield a total color hue light intensity LI_BP_tot.

In step 8 this total color hue light intensity LI_BP_tot is transformed into an input signal ES_BP processable by video display unit 2.

In step S20 display 9 of the object is then generated. The selected pixels, their calculated processable input signals, and their positions predefined by surface model 8 are used for this.

FIG. 11 details step S5, i.e., it illustrates how color hue light intensity LI_BP_1 of pixel BP resulting from the first illumination is calculated.

In step S9, a normal \vec{n} for pixel BP is calculated.

In step S10, angle θ1 between normal \vec{n} and first direction of illumination \vec{r1} is calculated.

In step S11, predefined first brightness function HF1 is applied to angle θ1 in order to calculate HF1(θ1).

In step S21, first illumination value BL1_BP is calculated from predefined basic color hue FT_BP and function value HF1 (θ1).

In step S18, a direction of viewing \vec{v} is calculated from a predefined viewing position BPos, in particular in the case of a central projection.

In step S12, predefined or calculated direction of viewing \vec{v} is mirrored on normal \vec{n}, yielding mirrored direction of viewing \vec{s}.

In step S13, angle ρ1 between mirrored direction of viewing \vec{s} and first direction of illumination \vec{r1} is calculated.

In step S14, predefined first highlight function GF1 is applied to angle ρ1 to calculate GF1(ρ1).

In step S22, first highlight value GW_BP is calculated from predefined highlight color hue GF_BP and function value GF1(ρ1).

In step S16 first brightness value HW1_BP is calculated. For this purpose, illumination value HW1_BP and highlight value GW1_BP are combined to yield the first brightness value, e.g., by addition.

In step S17 first color hue light intensity LI_BP_1 is calculated. Therefore, first brightness value HW1_BP, predefined basic color hue FT_BP pf pixel BP, and predefined color hue light intensity LI_LQ1 of the first illumination are used for this purpose.

Sequence S9-S10-S11 and sequence S18-S12-S13-S14 may be executed sequentially or simultaneously.

A computer-accessible desk display 9 of the illuminated object is generated. This is done in step S20 of FIG. 20. This display 9 is generated with the help of surface model 8 in the exemplary embodiment. It includes the selected pixels and their positions and calculated resulting color hue light intensities.

In the exemplary embodiment described so far, display 9 is transmitted to video display unit 2 immediately after being generated and is displayed by it. In a modification of this embodiment, instead of this, a file is generated, which includes generated display 9. At a desired point in time, this file is transmitted to video display unit 2 and displayed by it. The transmission is performed, e.g., from a CD or another mobile data medium or via the Internet or another data network. It is possible for a first data processing system to generate the file having display 9 and for a second processing system to analyze this file and exhibit display 9.

In the example in FIG. 15 and FIG. 16, the illuminated object is a spherical part of a motor vehicle and has a matte surface. This part is illuminated by two artificial sources. The first light source illuminates the spherical part from an angle of 120° and the second light source illuminates it from an angle of 230° from a predefined reference direction of viewing. Between first and second direction of illumination there is thus an angle of 110°. Angle Θ between specific direction of viewing \vec{v} and a varying direction of normal \vec{n} is plotted on the x axis.

In the example of FIG. 15, a display 9 containing light intensities in the form of gray tones is generated. In this example video display unit 2 is capable of processing input signals between 0 and 1 (inclusive). For example, 0 represents a “black” gray tone, and 1 represents a “white” gray tone. The interval from 0 to 1 is thus used as the input signal set. Video display unit 2 displays a pixel as a function of an input signal between 0 and 1 (inclusive), using a light intensity which is greater, the greater the input signal.

The two input signals are generated by transformation of the two light intensities into the input signal set. The first input signal of a pixel is proportional to the cosine of the angle between first direction of illumination \vec{r1} and a normal \vec{n} in the pixel on the surface of surface model 8 for the object. The second input signal of a pixel is proportional to the cosine of the angle between second direction of illumination \vec{r2} and normal \vec{n} on the surface of surface model 8 for the vehicle part in the pixel. Curves 31 and 32 of FIG. 15 show the variation of the first and second input signal, respectively, as a function of this angle.

The two light sources in the example in FIG. 15 are not ideal light sources emitting parallel light, because with ideal light sources, the incident light intensity would be proportional to the cosine of the angle (Lambert's law) but the input signals would not. These input signals depend on video display unit 2.

Curve 33 shows the sum of the two input signals. It has its maximum at the center at an angle of 175° and must be cut off at 1 in order for the sum to be between 0 and 1 and to supply a processable input signal in this example. This curve does not correspond to the physical reality.

Curve 34 shows the input signal calculated by the method according to the present invention. It correctly describes the physical reality: the curve of the input signal has two maximums (“peaks”). The light intensity declines between the two light sources, i.e., for angles Θ between 120° and 230°.

Curve 34 is a function of the first and second input signals and the two light intensities as follows: let LI_1 and LI_2 be the two light intensities of a pixel. Let ES_1 and ES_2 be the two individual input signals whose curves are represented by curves 31 and 32 as a function of the angle. It holds that ES_1=LI_1^{γ}^{_{—}}^{comp} and ES_1=LI_1^{γ}^{_{—}}^{comp}. Let ES be the input signal generated according to the present invention, whose variation is represented by curve 34. It holds that
ES=[LI_{—}1+LI_{—}2]^{γ}^{_{—}}^{comp}=[ES_{—}1^{1/γ}^{_{—}}^{comp}+ES_{—}2^{1/γ}^{_{—}}^{comp}]γ^{_{—}}^{comp}.

FIG. 16 shows at the left a diagram generated using the (physically incorrect) combination according to curve 33 in FIG. 15. FIG. 16 at the right shows a physically correct diagram generated using curve 34 in FIG. 15.

List of reference numerals and symbols used.

| Character | Meaning |
|---|---|
| 1 | Computing unit for performing calculations |
| 2 | Video display unit |
| 3 | Data memory having surface model 8 |
| 4 | First input device in the form of a computer mouse |
| 5 | Second input device in the form of a keyboard |
| 6 | Graphics card for generating input signals |
| 8 | Computer-accessible surface model of the object |
| 9 | Display of the object using pixels |
| 11 | Graph of the second brightness function (punctiform or directional light |
| | source) |
| 12 | Graph of the first brightness function (isotropic sky) |
| 13 | Graph of the first brightness function (traditional overcast sky) |
| 22 | Graph of the brightness function for the isotropic sky |
| 23 | Graph of the brightness function for the traditional overcast sky |
| 26 | Graph of an affine linear combination of two brightness functions, c = 0 |
| 27 | Graph of an affine linear combination of two brightness functions, c = 2 |
| 28 | Graph of an affine linear combination of two brightness functions, c = 5 |
| 31 | Curve of the input signal as a function of the angle between the first |
| | direction of illumination and normal \vec{n} |
| 32 | Curve of the input signal as a function of the angle between the second |
| | direction of illumination and normal \vec{n} |
| 33 | Curve of the sum of the two input signals of curve 31 and curve 32 |
| 34 | Curve of the input signal in the calculation according to the present |
| | invention |
| 110 | Brightness function HF of the isotropic sky |
| 111, 112, 113, 114 | Highlight functions GF of the isotropic sky |
| 119 | Light distribution function LVF of the isotropic sky |
| 120 | Brightness function HF of the cosine sky |
| 121, 122, 123, 124 | Highlight functions GF of the cosine sky |
| 129 | Light distribution function LVF of the cosine sky |
| 130 | Brightness function HF of the traditional overcast sky |
| 131, 132, 133, 134 | Highlight functions GF of the traditional overcast sky |
| 139 | Light distribution function LVF of the traditional overcast sky |
| 140 | Brightness function pHF of a punctiform light source |
| 141, 142, 143, 144 | Highlight functions pGF of a punctiform light source |
| 151, 152, 153, 154 | Graphs of function ICOSN |
| BL1_BP | First illumination value of pixel BP resulting from the first illumination |
| | without taking into account highlights |
| BL1_BP_b | Blue value of first illumination value BL1_BP |
| BL1_BP_g | Green value of first illumination value BL1_BP |
| BL1_BP_r | Red value of first illumination value BL1_BP |
| BL2_BP | Second illumination value of pixel BP resulting from the second |
| | illumination without taking into account highlights |
| BL2_BP_b | Blue value of second illumination value of BL2_BP |
| BL2_BP_g | Green value of second illumination value of BL2_BP |
| BL2_BP_r | Red value of second illumination value of BL2_BP |
| BP | Selected pixel |
| dist(LQ, G) | Distance between the light source and the object |
| dist_ref | Given reference distance from light source; light intensity is based on this |
| | reference distance |
| ε_BG | Black tone error of display unit 2 |
| η | Difference angle for varied brightness function vHF |
| E1 | Result: surface elements of the surface of surface model 8 |
| E2 | Result: surface elements visible from direction of viewing \vec{v} |
| E3 | Result: selected pixels |
| ES_BP | Input signal for pixel BP |
| ES_BP_b | Blue value of input signal ES_BP for pixel BP |
| ES_BP_g | Green value of input signal ES_BP for pixel BP |
| ES_BP_r | Red value of input signal ES_BP for pixel BP |
| FT_BP | Given basic color hue of selected pixel BP |
| FT_BP_b | Blue value of basic color hue FT_BP |
| FT_BP_g | Green value of basic color hue FT_BP |
| FT_BP_r | Red value of basic color hue FT_BP |
| γ_comp | Factor for compensation of the gamma behavior of video display unit 2 |
| Γ | Gamma transfer function |
| Γ⁻¹ | Inverse function of γ-transfer function |
| γ_BG | Gamma factor of video display unit 2 |
| γ_comp | Factor for compensation of the gamma behavior |
| γ_view | Viewing gamma factor |
| GF1 | Given highlight function of the first illumination |
| GF2 | Given highlight function of the second illumination |
| GFT_BP | Highlight function of pixel BP |
| GFT_BP_r | Red value of highlight color hue GFT_BP |
| GFT_BP_g | Green value of highlight color hue GFT_BP |
| BFT_BP_b | Blue value of highlight color hue GFT_BP |
| GSF | Highlight scattering function (rotationally symmetrical) |
| GW1_BP | First highlight value of pixel BP |
| GW1_BP_b | Blue value of first highlight value GW1_BP |
| GW1_BP_g | Green value of first highlight value GW1_BP |
| GW1_BP_r | Red value of first highlight value GW1_BP |
| GW2_BP | Second highlight value of pixel BP |
| GW2_BP_b | Blue value of second highlight value GW2_BP |
| GW2_BP_g | Green value of second highlight value GW2_BP |
| GW2_BP_r | Red value of second highlight value GW2_BP |
| HF1 | Given brightness function of the first illumination (diffuse light source) |
| HF2 | Brightness function of the second illumination (punctiform or directional |
| | light source) |
| HS² | Upper hemisphere |
| HW1_BP | First brightness value of selected pixel BP resulting from the first |
| | illumination |
| HW1_BP_b | Blue value of first brightness value HW1_BP |
| HW1_BP_g | Green value of first brightness value HW1_BP |
| HW1_BP_r | Red value of first brightness value HW1_BP |
| HW2_BP | Second brightness value of selected pixel BP resulting from the second |
| | illumination |
| HW2_BP_b | Blue value of second brightness value HW2_BP |
| HW2_BP_g | Green value of second brightness value HW2_BP |
| HW1_BP_r | Red value of second brightness value HW2_BP |
| \vec{l} | Vector from the object to an illumination surface element |
| Λ | Simplified integration range: spherical digon |
| LI_BG_max_b | Blue value of a pure white having max. light intensity displayable by |
| | video display unit 2 |
| LI_BG_max_g | Green value of a pure white having max. light intensity displayable by |
| | video display unit 2 |
| LI_BG_max_r | Red value of a pure white having max. light intensity displayable by |
| | video display unit 2 |
| LI_BP_1 | Calculated color hue light intensity of pixel BP resulting from the first |
| | illumination |
| LI_BP_1_b | Blue value of color hue light intensity LI_BP_1 resulting from the first |
| | illumination |
| LI_BP_1_g | Green value of color hue light intensity LI_BP_1 resulting from the first |
| | illumination |
| LI_BP_1_r | Red value of color hue light intensity LI_BP_1 resulting from the first |
| | illumination |
| LI_BP_1_comp | Gamma behavior-compensating color hue light intensity resulting from |
| | the first illumination |
| LI_BP_2 | Calculated color hue light intensity of pixel BP resulting from the second |
| | illumination |
| LI_BP_2_b | Blue value of color hue light intensity LI_BP_1 resulting from the second |
| | illumination |
| LI_BP_2_g | Green value of color hue light intensity LI_BP_1 resulting from the |
| | second illumination |
| LI_BP_2_r | Red value of color hue light intensity LI_BP_1 resulting from the second |
| | illumination |
| LI_BP_2_comp | Gamma behavior-compensating color hue light intensity resulting from |
| | the second illumination |
| LI_BP_tot | Total color hue light intensity of pixel BP calculated by combining of |
| | LI_BP_1 and LI_BP_2 |
| LI_BP_tot_b | Blue value of combined color hue light intensity LI_BP_tot |
| LI_BP_tot_g | Green value of combined color hue light intensity LI_BP_tot |
| LI_BP_tot_r | Red value of combined color hue light intensity LI_BP_tot |
| LI_BP_tot_comp | Gamma behavior-compensating total color hue light intensity of pixel BP |
| LI_LQ_1 | Given color hue light intensity of the first illumination on the surface of |
| | the object |
| LI_LQ_1_b | Blue value of given color hue light intensity LI_LQ_1 of the first |
| | illumination |
| LI_LQ_1_g | Green value of given color hue light intensity LI_LQ_1 of the first |
| | illumination |
| LI_LQ_1_r | Red value of given color hue light intensity LI_LQ_1 of the first |
| | illumination |
| LI_LQ_1_ref | Given color hue light intensity of the first illumination from reference |
| | distance dist_ref |
| LI_LQ_1_ref_b | Blue value of given color hue light intensity LI_LQ_1_ref of the first |
| | illumination from reference distance dist_ref |
| LI_LQ_1_ref_g | Green value of given color hue light intensity LI_LQ_1_ref of the first |
| | illumination from reference distance dist_ref |
| LI_LQ_1_ref_r | Red value of given color hue light intensity LI_LQ_1_ref of the first |
| | illumination from reference distance dist_ref |
| LI_LQ_2 | Given color hue light intensity of the second illumination on the surface |
| | of the object |
| LI_LQ_2_b | Blue value of given color hue light intensity LI_LQ_1 of the second |
| | illumination |
| LI_LQ_2_g | Green value of given color hue light intensity LI_LQ_1 of the second |
| | illumination |
| LI_LQ_2_r | Red value of given color hue light intensity LI_LQ_1 of the second |
| | illumination |
| LVF | Light distribution function |
| \vec{n} | Normal vector in a surface element of surface model 8 |
| Ω | Intersection of hemisphere HS² with the positive normal space of the |
| | surface element and the positive half-space with respect to \vec{s}, exact |
| | integration range |
| \vec{r1} | First direction of illumination; direction of diffuse lighting |
| \vec{r2} | Second direction of illumination; direction of punctiform or directional |
| | lighting |
| ρ1 | Angle between mirrored direction of viewing \vec{s} and first direction of |
| | illumination \vec{r1} |
| ρ2 | Angle between mirrored direction of viewing \vec{s} and second direction of |
| | illumination \vec{r2} |
| \vec{s} | Direction of viewing \vec{v} mirrored at normal \vec{n} |
| S² | Total sphere |
| σ | Angle between vector \vec{l} to illumination surface element and mirrored |
| | direction of viewing vector \vec{s} |
| S1 | Breakdown of surface model 8 |
| S2 | Calculation of normal \vec{n} to the surface elements |
| S3 | Determination of the surface elements visible from direction of viewing \vec{v} |
| S4 | Selection of pixels |
| S5 | Calculation of first color hue light intensity LI_BP_1 |
| S6 | Calculation of first color hue light intensity LI_BP_2 |
| S7 | Combination of color hue light intensity LI_BP_1 and LI_BP_2 to total |
| | color hue light intensity LI_BP_tot |
| S8 | Transformation of total color hue light intensity LI_BP_tot into |
| | processable input signals ES_BP |
| S9 | Calculation of normal \vec{n} for pixel BP |
| S10 | Calculation of angle θ1 between normal \vec{n} and first direction of |
| | illumination \vec{r1} |
| S11 | Use of first brightness function HF1 to angle θ1 |
| S12 | Mirroring of direction of viewing \vec{v} on normal \vec{n} |
| S13 | Calculating angle ρ1 between mirrored direction of viewing \vec{s} and first |
| | direction of illumination \vec{r1} |
| S14 | Application of first highlight function GF1 to angle ρ1 |
| S15 | Calculation of the color hue light intensity of the first light source as a |
| | function of the given color hue light intensity and the distance between |
| | the first light source and the object |
| S16 | Calculation of first brightness value HW1_BP |
| S17 | Calculation of first color hue light intensity LI_BP_1 |
| S18 | Calculation of direction of viewing \vec{v} as a function of viewing position |
| | BPos |
| S20 | Generation of display 9 |
| S21 | Calculation of first illumination value BL1_BP as a function of basic |
| | color hue FT_BP and function value HF(θ1) |
| S22 | Calculation of first highlight value GW1_BP from highlight color hue |
| | GFT_BP and function value GF1(ρ1) |
| θ1 | Angle between normal vector \vec{n} in pixel BP and first direction of |
| | illumination \vec{r1} |
| θ2 | Angle between normal vector \vec{n} in pixel BP and second direction of |
| | illumination \vec{r2} |
| \vec{v} | Given direction of viewing to the object from which display 9 shows the |
| | object |
| vHF | Given varied brightness function |

1-44. (canceled)

45. A method for automatically generating a three-dimensional computer-accessible display of an illuminated object, a computer-accessible three-dimensional surface model of the object, a breakdown of the surface model into surface elements, a direction of illumination from an illumination acting on the object, and a brightness function being predefined, the brightness function having angles from 0° to 180° as a set of arguments and a function value 0 being assigned to each argument of 180°, and one function value greater than 0 being assigned to each argument less than 180°, the method comprising the steps of:
for each surface element,
calculating at least one normal of the surface element;
calculating an angle (θ) between the normal and the direction of illumination, and
calculating a function value assumed by the brightness function for the angle (η),
the function value being used as a brightness value of the surface element; and,
generating the three-dimensional display using the surface elements and the brightness values so that a surface element is displayed more brightly the greater the respective brightness value.

46. The method as recited in claim 45 wherein each surface element has at least three corner points; a normal of the corner point is calculated for each corner point of each surface element, and independently of the corner point normals of each surface element, a normal is calculated and used as the normal of the surface element.

47. The method as recited in claim 45 wherein a direction vector running in the direction of the illumination pointing outward relative to the surface model is calculated and a normal vector which points outward relative to the surface model is calculated for each surface element.

48. The method as recited in claim 47 wherein the brightness function is a function of a cosine of the angle (θ), and for each surface element the cosine of the angle (θ) is calculated with the help of a scalar product and lengths of the normal vector and the direction vector, and the brightness value of the surface element is calculated as a function of the cosine of the angle (θ).

49. The method as recited in claim 45 wherein a differential angle (η) between 0° and 90° and a varied brightness function are predefined, the varied brightness function having angles from 0 to 180° as the set of arguments and assigns the value 0 to each angle greater than a difference between 180° and the differential angle (η) and assigns one value greater than 0 to each angle smaller than this difference,
and for each surface element
the function value assumed by the varied brightness function for the differential angle as its argument is calculated,
and the function value of the varied brightness function is calculated as the brightness value of the surface element.

50. A method for automatically generating a three-dimensional computer-accessible display of an illuminated object from one direction of viewing, a computer-accessible three-dimensional surface model of the object, a breakdown of the surface model into surface elements, a direction of illumination from an illumination acting on the object, a direction of viewing as a direction from which the display to be generated shows the object, and a highlight function being predefined, the highlight function having the angles from 0° to 180° as the set of arguments and assigning the function value 0 to the argument 180° and assigning one function value greater than 0 to each argument smaller than 180°, the method comprising the steps of:
for each surface element,
calculating at least one normal,
calculating an angle (θ) between the normal and the direction of illumination and
calculating an illumination value of the surface element as a function of the angle (θ),
mirroring the direction of viewing about the normal of the surface element, calculating the angle (ρ) between the mirrored direction of viewing and the direction of illumination,
calculating a highlight value of the surface element as a function value assumed by the highlight function for the angle (ρ), and
combining the illumination value and the highlight value into one brightness value of the surface element, and
generating and displaying the three-dimensional display of the object by using the surface elements and their brightness values so that each surface element is displayed more brightly the greater the respective brightness value.

51. The method as recited in claim 50 wherein the brightness value of the surface element is calculated by addition of the illumination value and the highlight value of the surface element.

52. The method as recited in claim 50 wherein each surface element has at least three corner points; for each corner point of a surface element a normal of the corner point is calculated, a direction of viewing is mirrored about the normal of the corner point, the angle (ρ) between the mirrored direction of viewing and the direction of illumination and the function value assumed by the highlight function for the angle (ρ) are calculated, and the highlight value of the surface element is calculated as a function of the function values of the highlight function calculated for the corner points of the surface element.

53. The method as recited in claim 52 wherein at least one surface element includes multiple points and the illumination value is calculated for each of these points as a function of a position of the point in relation to the corner points of the surface element and the function values of the highlight function calculated for the corner points of the surface element.

54. The method as recited in claim 50 wherein each surface element has at least three corner points; for each corner point of each surface element a normal of the corner point is calculated, the direction of viewing is mirrored about the normal of the corner point, the angle between the normal and the mirrored direction of viewing and the function value assumed by the highlight function for this angle (ρ) are calculated, and the highlight value of the surface element is calculated as a function of the function values of the highlight function calculated for the corner points of the surface element.

55. The method as recited in claim 50 wherein the highlight function is a function of the cosine of the angle (ρ) between the mirrored direction of viewing and the direction of illumination, a direction vector running in the direction of illumination and pointing outward relative to the surface model is calculated, and for each surface element a mirrored direction of viewing vector is calculated describing the mirrored direction of viewing and pointing outward relative to the surface model, the cosine of the angle (ρ) between the mirrored direction of viewing vector and the direction vector is calculated with the help of a scalar product and lengths of the mirrored direction of viewing vector and the direction vector, and the highlight value of the surface element is calculated with the help of a predefined function of the cosine of the angle (ρ).

56. A method for automatically generating a computer-accessible display of an illuminated physical object on a video display unit of a data processing system, a first direction of illumination being a direction from which a first illumination acts on the object, a second direction of illumination being a direction from which a second illumination acts on the object, and a computer-accessible surface of the object being predefined, the method comprising the following steps, performed automatically:
selecting pixels of the surface model,
calculating a first light intensity of at least one of the pixels resulting from the first illumination of the object from the first direction of illumination,
calculating a second light intensity of the pixel resulting from the second illumination of the object from the second direction of illumination,
selecting a total light intensity of the pixel for each selected pixel as a function of the two light intensities of the pixel,
transforming the total light intensity of each selected pixel into an input signal for the pixel processable by the video display unit,
generating the display of the physical object using the selected pixels and the input signals of the pixels,
transmitting the display to the video display unit and displaying it on the video display unit,
wherein each pixel is displayed on the video display unit with a display light intensity which is a function of the input signal.

57. The method as recited in claim 56 wherein a direction of viewing toward the object is predefined, areas of the surface of the surface model that are visible from the direction of viewing are determined, only those pixels located in a visible area of the surface are selected, and the display is generated so that the display shows the object from the direction of viewing.

58. The method as recited in claim 56 wherein a normal to the surface model at the pixel is calculated, a first angle between the normal and the first direction of illumination is calculated, a second angle between the normal and the second direction of illumination is calculated, the first light intensity of the pixel being calculated as a function of the first angle, and the second light intensity of the pixel being calculated as a function of the second angle.

59. The method as recited in claim 56 wherein a first brightness function and a second brightness function are predefined, the first light intensity of each pixel being calculated using the function value of the first brightness function for the first angle, and the second light intensity of each pixel being calculated using the function value of the second brightness function for the second angle.

60. The method as recited in claim 56 wherein a distance of the object from the light source of the first illumination is predefined as a first distance and a distance of the object from the light source of the second illumination is predefined as a second distance, for each selected pixel the first light intensity of the pixel is calculated as a function of the first distance and for each selected pixel the second light intensity of the pixel is calculated as a function of the second distance.

61. The method as recited in claim 56 wherein a first color hue light intensity of the first illumination and a second color hue light intensity of the second illumination are selected, and for each selected pixel one basic color hue is selected, wherein the color hue light intensities describe the color hues and light intensities of the two illuminations, and each basic color hue describes the color hue of a pixel, and for each selected pixel, a first color hue light intensity of the pixel is calculated as a function of the first direction of illumination, the basic color hue of the pixel and the first color hue light intensity and is used as the first light intensity of the pixel,
a second color hue light intensity of the pixel is calculated as a function of the second direction of illumination, the basic color hue of the pixel and the second color hue light intensity and is used as the second light intensity of the pixel, and
a total color hue light intensity of the pixel is calculated as a function of the two color hue light intensities of the pixel and used as the total light intensity of the pixel.

62. The method as recited in claim 61 wherein the total color hue light intensity of each selected pixel is transformed into an RGB vector processable by the video display unit, and the RGB vector is used as the input signal for the pixel.

63. The method as recited in claim 56 wherein the video display unit has a gamma behavior which influences the display light intensities of the pixels, and the total light intensity of each selected pixel is transformed into an input signal such that the input signal transmitted to the video display unit compensates for gamma behavior of the video display unit.

64. The method as recited in claim 63 wherein for each selected pixel, a processable signal depending on the total light intensity in the transformation of the calculated total light intensity, and an input signal compensating for the gamma behavior is calculated as a function of this signal and is transmitted as the input signal for the pixel.

65. The method as recited in claim 63 wherein for each selected pixel, a total light intensity of the pixel compensating for the gamma behavior is calculated as a function of the calculated light intensity, and the input signal for the pixel is calculated by transformation of the compensating total light intensity.

66. The method as recited in claim 56 wherein the video display unit has a gamma behavior that influences the display light intensities of the pixels, for each selected pixel, a first light intensity of the pixel compensating for the gamma behavior is calculated as a function of the first light intensity of the pixel, for each selected pixel, a second light intensity of the pixel compensating for the gamma behavior is calculated as a function of the second light intensity of the pixel, a compensating total light intensity of the pixel compensating for the gamma behavior is calculated for each selected pixel as a function of the two compensating light intensities of the pixel and is used as the total light intensity of the pixel.

67. A method for automatically generating a computer-accessible display of an illuminated physical object on a video display unit of a data processing system, a light intensity of an illumination of the object, a distance between a light source of the illumination and the object and a computer-accessible surface model of the object being predefined, the method comprising the following steps that are performed automatically:
selecting pixels of the surface model,
calculating for each selected pixel, a light intensity of the pixel resulting from the illumination of the object for each selected pixel as a function of a light source light intensity and a square of the distance between the light source and the object,
transforming, for each selected pixel, the resulting light intensity of the pixel into an input signal of the pixel processable by the video display unit,
generating the display of the object using the selected pixels and the input signals of the pixels,
transmitting the display to the video display unit and displaying the display on the video display unit,
wherein each selected pixel is displayed on the video display unit with a display light intensity which is a function of the input signal of the pixel.

68. The method as recited in claim 67 wherein an intensity of the illumination produced by the light source from a given reference distance is predefined as the illumination light intensity, and for each selected pixel the resulting light intensity of the pixel is calculated as a function of a square of a quotient of the reference distance and the distance between the light source and the object.

69. The method as recited in claim 67 wherein for each selected pixel the distance between the light source and the pixel is calculated as a function of the given distance between the light source and the object and the resulting light intensity of the pixel is calculated as a function of the light source light intensity and the square of the distance between the light source and the pixel.

70. The method as recited in claim 69 wherein the resulting light intensity of each selected pixel is calculated as a function of the product of a factor which depends on the light source light intensity and the inverse of the square of the distance between the light source and the pixel.

71. The method as recited in claim 67 wherein a color hue light intensity of the illumination is predefined, the color hue light intensity describing the color hue and the light intensity of the illumination, a basic color hue describing the color hue of the pixel is predefined for each selected pixel, a resulting color hue light intensity of the pixel is calculated for each selected pixel as a function of the given color hue light intensity of the illumination, the basic color hue of the pixel and the surface model and is used as the resulting light intensity of the pixel.

72. A method for generating a computer-accessible display of an illuminated physical object on a video display unit of a data processing system, the video display unit having a gamma behavior such that a display light intensity with which the video display unit displays a pixel increases over-proportionately with an electric input signal for a setpoint light intensity of the pixel transmitted to the video display unit, and a computer-accessible surface model of the object is predefined, the method comprising the following steps that are performed automatically:
selecting the pixels of the surface model,
calculating for each selected pixel the setpoint light intensity of the pixel as a function of an illumination of the object and the surface model,
calculating a compensating light intensity of the pixel compensating for the gamma behavior of the video display unit for each selected pixel as a function of the setpoint light intensity of the pixel,
transforming the compensating light intensity of each selected pixel into an input signal for the pixel processable by the video display unit,
generating the display of the object using the selected pixels and the input signals of the pixels,
transmitting the display to the video display unit displaying the display on the video display unit,
wherein each selected pixel is displayed on the video display unit with a display light intensity which is a function of the input signal.

73. The method as recited in claim 72 wherein a direction of viewing to the object is predefined, a determination is made of which areas of the surface of the surface model are visible from the direction of viewing, only those pixels situated in a visible area of the surface are selected, and the display is generated in such a way that it displays the object from the direction of viewing.

74. The method as recited in claim 72 wherein the video display unit is exposed to an ambient illumination and the compensating light intensity of each selected pixel compensating for the gamma behavior of the video display unit is calculated as a function of the ambient illumination.

75. The method as recited in claim 74 wherein the compensating light intensity of each selected pixel compensating for the gamma behavior of the video display unit is calculated as a function of the quotient of a viewing gamma factor which is a function of the ambient illumination and a gamma factor which is a function of the gamma behavior of the video display unit.

76. The method as recited in claim 72 wherein the light intensity of each selected pixel compensating for the gamma behavior of the video display unit is transformed into an RGB vector processable by the video display unit, and the RGB vector is used as the input signal for the pixel.

77. The method as recited in claim 72 wherein a color hue light intensity of the illumination is predefined, the color hue light intensity describing the color hue and the light intensity of the illumination, a basic color hue describing the color hue of the pixel is predefined for each selected pixel, a setpoint color hue light intensity of the pixel is calculated for each selected pixel as a function of the predefined color hue light intensity of the illumination, the basic color hue of the pixel and the surface model, the calculated setpoint color hue light intensity of a pixel describing the color hue and the light intensity of the illuminated object in the pixel and for each selected pixel a compensating color hue light intensity of the pixel which compensates for the gamma behavior of the video display unit being selected as a function of the setpoint color hue light intensity of the pixel and used as the compensating light intensity of the pixel.

78. The method as recited in claim 77 wherein a compensating color hue light intensity of the illumination compensating for the gamma behavior of the video display unit is predefined, the color hue light intensity of the illumination is calculated from the compensating color hue light intensity, and for each selected pixel a compensating basic color hue which compensates for the gamma behavior of the video display unit is predefined and the basic color hue of the pixel is calculated from the compensating basic color hue.

79. A data processing system having a processing unit designed for automatically generating a three-dimensional computer-accessible display of an illuminated object and has reading access to a computer-accessible three-dimensional surface model of the object, to a computer-accessible breakdown of the surface model into surface elements, to a computer-accessible representation of a direction of illumination being a direction of the illumination acting on the object, and to a computer-accessible brightness function, in which the brightness function has angles from 0° to 180° as the set of arguments and assigns function value 0 to the argument 180° and one function value greater than 0 is assigned to each argument less than 180°, the processing unit configured to perform the following steps:
calculating at least one normal of the surface element for each surface element,
calculating an angle (θ) between the normal and the direction of illumination for each surface element,
calculating at least one brightness value as a function value assumed by the brightness function for the angle (θ) for each surface element, and
generating the three-dimensional display of the object using the surface elements and the brightness values in such a way that a surface element is brighter in the display the greater the respective brightness value.

80. A data processing system having an arithmetic unit configured for automatically generating a three-dimensional computer-accessible display of an illuminated object and has reading access to a computer-accessible three-dimensional surface model of an object, to a computer-accessible breakdown of the surface model into surface elements, to a computer-accessible representation of a direction of illumination being a direction from which an illumination acts on the object, to a computer-accessible representation of a direction of viewing as a direction from which the display to be generated shows the object, and to a computer-accessible representation of a brightness function and a highlight function, in which the brightness function and the highlight function each have the angles from 0° to 180° as the set of arguments and assign a function value of 0 to the argument of 180° and one function value greater than 0 to each argument less than 180°, the arithmetic unit being configured to execute the following operations:
for each surface element,
calculating at least one normal of the surface element,
calculating an angle (θ) between the normal and the direction of viewing,
mirroring the direction of viewing about the normal of the surface element,
calculating an angle (ρ) between the mirrored direction of viewing and the direction of illumination,
calculating an illumination value as a function of the angle (ρ) between the normal and the direction of illumination,
calculating a highlight value as a function value assumed by the highlight function for the angle (ρ) between the mirrored direction of viewing and the direction of illumination, and
combining the illumination value and the highlight value to yield a brightness value of the surface element, and
using the surface elements and their brightness values to generate the three-dimensional display of the object in such a way that each surface element is displayed more brightly the greater the respective brightness value.

81. A data processing system comprising:
an information distribution interface to a data memory storing a computer-accessible surface model of a physical object and a computer-accessible illumination description of an illumination of the object, and
an information distributing interface to a video display unit, in which the illumination description includes a first direction of illumination as a direction from which a first illumination acts on the object and a second direction of illumination as a direction from which a second illumination acts on the object,
the data processing system being configured to perform the following steps:
selecting pixels of the surface model,
for each selected pixel, calculating a first light intensity of the pixel resulting from the first illumination of the object as a function of the first direction of illumination,
for each selected pixel, calculating a second light intensity of the pixel resulting from the second illumination of the object as a function of the second direction of illumination,
for each selected pixel, calculating a total light intensity of the pixel as a function of the two light intensities of the pixel,
transforming the total light intensity of each selected pixel to yield an input signal for the pixel processable by the video display unit,
generating a computer-accessible display of the illuminated object using the selected pixels and the input signals of the pixels,
transmitting the display to the video display unit and
displaying the display on the video display unit so that the video display unit displays each selected pixel with a display light intensity which is a function of the input signal.

82. A data processing system, comprising:
an information distribution interface to a data memory storing a computer-accessible surface model of a physical object and a computer-accessible illumination description of an illumination of the object are stored, and an information distribution interface to a video display unit, the illumination description including a light intensity of the illumination of the object and a distance between the light source of the illumination and the object, the data processing system being configured to perform the following steps:
selecting pixels of the surface model,
for each selected pixel, calculating a light intensity of the pixel resulting from the illumination of the object as a function of the light source light intensity and the square of the distance between the light source and the object,
for each selected pixel transforming the resulting light intensity of the pixel into an input signal of the pixel processable by the video display unit,
generating a computer-accessible display of the illuminated object using the selected pixels and the input signals of the pixels,
transmitting the display to the video display unit and
displaying the display on the video display unit so that the video display unit displays each selected pixel with a display light intensity which is a function of the input signal of the pixel.

83. A data processing system, comprising:
an information distribution interface to a data memory storing a computer-accessible surface model of a physical object and a computer-accessible illumination description of an illumination of the object are stored, and an information distribution interface to a video display unit, the video display unit having a gamma behavior such that the display light intensity with which the video display unit displays a pixel increases over-proportionately with an electric input signal transmitted to the video display unit for a setpoint light intensity of the pixel, the data processing system being configured to perform the following steps:
selecting pixels of the surface model,
for each selected pixel, calculating the setpoint light intensity of the pixel as a function of the illumination of the object and as a function of the surface model,
for each selected pixel, calculating a compensating light intensity of the pixel which compensates for the gamma behavior of the video display unit as a function of the setpoint light intensity of the pixel,
transforming the compensating light intensity of each selected pixel into an input signal for the pixel processable by the video display unit,
generating a computer-accessible display of the illuminated object using the selected pixels and the input signals of the pixels,
transmitting the display to the video display unit, and
displaying the display on the video display unit so that the video display unit displays each selected pixel with a display light intensity which depends on the input signal.

84. A computer program product for automatically generating a three-dimensional computer-accessible display of an illuminated object, the computer program product being loadable into an internal memory of the computer and comprising:
software sections executing the following steps when the computer program product is running on the computer:
inputting of a computer-accessible three-dimensional surface model of the object and a breakdown of the surface model into surface elements;
inputting of a direction of illumination as a direction of the illumination acting on the object,
for each surface element calculating at least one normal of the surface element, for each surface element calculating an angle between the normal and the direction of
illumination and
for each surface element calculating at least one brightness value as the function value assumed by a predefined computer-accessible brightness function for the angle,
the brightness function having angles from 0° to 180° as the set of arguments and assigning a function value of 0 to the argument of 180° and one function value greater than 0 to each argument less than 180°,
generating the three-dimensional display of the object using the surface elements and the brightness values so that a surface element is displayed more brightly the greater the respective brightness value.

85. A computer program product for automatically generating a three-dimensional computer-accessible display of an illuminated object, the computer program product being loadable into an internal memory of the computer and comprising:
software sections executing the following steps when the computer program product is running on the computer:
inputting of a computer-accessible three-dimensional surface model of the object and a breakdown of the surface model into surface elements and
inputting of a computer-accessible direction of illumination as a direction of the illumination acting on the object,
entering a computer-accessible direction of viewing as a direction from which the display to be generated is directed to the object,
for each surface element calculating at least one normal of the surface element,
for each surface element calculating an angle between the normal and the direction of illumination and calculating a brightness value which is a function of the angle,
calculating an illumination value of the surface element as a function of the angle between the normal and the direction of illumination,
mirroring the direction of viewing about the normal of the surface element,
calculating a further angle between the mirrored direction of viewing and the direction of illumination,
calculating a highlight value as the function value assumed by a given computer-accessible highlight function for the further angle between the mirrored direction of viewing and the direction of illumination, the highlight function having angles from 0° to 180° as the set of arguments and assigning a function value of 0 to the argument of 180° and one function value greater than 0 to each argument less than 180°,
combining the illumination value and the highlight value to form a brightness value of the surface element, and
generating the three-dimensional display of the object using the surface elements and the brightness values so that a surface element is displayed more brightly the greater the respective brightness value.

86. A computer program product comprising:
an information distribution interface to a data memory storing a computer-accessible surface model of a physical object and a computer-accessible illumination description of an illumination of the object, and an information distribution interface to a video display unit, the illumination description including a first direction of illumination as a direction from which a first illumination acts on the object and a second direction of illumination as a direction from which a second illumination acts on the object, the computer program product being configured to perform the following steps:
selecting pixels of the surface model,
for each selected pixel, calculating a first light intensity of the pixel resulting from the first illumination of the object as a function of the first direction of illumination,
for each selected pixel, calculating a second light intensity of the pixel resulting from the second illumination of the object as a function of the second direction of illumination,
for each selected pixel, calculating a total light intensity of the pixel as a function of the first and second light intensities of the pixel,
transforming the total light intensity of each selected pixel to yield an input signal for the pixel processable by the video display unit,
generating a computer-accessible display of the illuminated object using the selected pixels and the input signals of the pixels,
transmitting the display to the video display unit, and
displaying the display on the video display unit so that the video display unit displays each selected pixel with a display light intensity which is a function of the input signal.

87. A computer program product comprising:
an information distribution interface to a data memory storing a computer-accessible surface model of a physical object and a computer-accessible illumination description of an illumination of the object, and an information distribution interface to a video display unit, the illumination description including a light intensity of the illumination of the object and a distance between the light source of the illumination and the object, the computer program product being configured to perform the following steps:
selecting pixels of the surface model,
for each selected pixel, calculating a light intensity of the pixel resulting from the illumination of the object as a function of a light source light intensity and a square of the distance between the light source and the object,
for each selected pixel, transforming the resulting light intensity of the pixel into an input signal of the pixel processable by the video display unit,
generating a computer-accessible display of the illuminated object using the selected pixels and the input signals of the pixels,
transmitting the display to the video display unit, and
displaying the display on the video display unit so that the video display unit displays each selected pixel with a display light intensity which is a function of the input signal of the pixel.

88. A computer program product comprising:
an information distribution interface to a data memory storing a computer-accessible surface model of a physical object and a computer-accessible illumination description of an illumination of the object and an information distribution interface to a video display unit, the video display unit having a gamma behavior such that a display light intensity with which the video display unit displays a pixel increases over-proportionally with an electric input signal transmitted to the display unit for a setpoint light intensity, the computer program product being configured to perform the following steps:
selecting pixels of the surface model,
for each selected pixel, calculating a setpoint light intensity of the pixel as a function of the illumination of the object and of the surface model,
for each selected pixel, calculating a compensating light intensity of the pixel compensating for the gamma behavior of the video display unit as a function of the setpoint light intensity of the pixel,
transforming the compensating light intensity of each selected pixel into an input signal for the pixel processable by the video display unit,
generating a display of the illuminated object using the selected pixels and the input signals of the pixels,
transmitting the display to the video display unit, and
displaying the display on the video display unit so that the video display unit displays each selected pixel with a display light intensity that is a function of the input signal.
